(19) United States
(12) Patent Application Publication
(10) Pub. No.: US 2016/0031249 A1
(43) Pub. Date: Feb. 4, 2016

(54) PRINTING APPARATUS AND PRINTING METHOD

(71) Applicant: CANON KABUSHIKI KAISHA, Tokyo (JP)

(72) Inventors: Hiromitsu Akiba, Yokohama-shi (JP); Nobutaka Miyake, Yokohama-shi (JP); Shinjiro Hori, Yokohama-shi (JP); Junichi Nakagawa, Tokyo (JP)

(21) Appl. No.: 14/807,649

(22) Filed: Jul. 23, 2015

(30) Foreign Application Priority Data
Jul. 30, 2014 (JP) 2014-154830

(51) Int. Cl. B41J 29/38

(52) U.S. Cl. CPC B41J 29/38

(57) ABSTRACT

A printing apparatus and a printing method are provided by which information printed on a printing medium can be used to appropriately control an image printing while allowing the entire printing apparatus to have a simpler and smaller configuration. An image is printed on a conveyed sheet by yellow, black, cyan, and magenta inks ejected from printing heads. The yellow ink ejected from the printing head is used to print an image in which information for sensing a sheet conveying amount is embedded by an electronic watermark. The information is read by a sensor unit. Based on the reading result, a printing control is performed. The printing head to eject yellow ink is positioned at an upstream side in a sheet conveying direction than the sensor unit. The printing head to eject black ink is positioned at a downstream side in the sheet conveying direction than the sensor unit.

### BACKGROUND OF THE INVENTION

1. Field of the Invention

The present invention relates to a printing apparatus and a printing method for printing an image using a plurality of color materials such as ink and toner.

2. Description of the Related Art

Japanese Patent Laid-Open No. 2007-1183 discloses a printing apparatus to eject ink as color material from a line head (long printing head) to thereby print an image on a continuously-conveyed printing medium. This printing apparatus is configured, in order to suppress the deviation of the image printing position due to the conveying error of the printing medium, to use a marker head and a marker reading unit. The marker head and the marker reading unit are provided at the upstream side in a printing medium conveying direction than the line head. The marker head is used to print a marker on a blank margin exterior to a printing region on the printing medium. The marker is read by the marker reading unit. Based on the result of reading the marker, the conveying amount of the printing medium is determined. Based on the determination result, the timing at which ink is ejected from the line head is controlled to thereby correct the deviation of the image printing position.

However, in the case of the printing apparatus disclosed in Japanese Patent Laid-Open No. 2007-1183, not only the line head for printing an image but also the marker head for printing the marker must be provided, thus causing a risk of the entire printing apparatus having an increased size and increased cost. Furthermore, the blank margin in which the marker is printed must be provided at the outside of the printing region on the printing medium, thus undesirably causing a proportional reduction of the region on the printing medium in which printing can be carried out. Furthermore, if the blank margin in which the marker is printed is set in a width direction orthogonal to the conveying direction of the printing medium, a risk of the printing apparatus having an increased size is caused. If the blank margin is set between printed images adjacent to each other in the conveying direction of the printing medium, the markers in the conveying direction of the printing medium have an increased interval thereamong, which causes a risk of the decline of the accuracy at which the conveying amount of the printing medium is determined (and thus the decline of the accuracy at which the deviation of the image printing position is corrected).

Furthermore, in order to print an image not including a blank margin (margin-less printing), a step after the printing is required to cut a part in which the marker is printed, which causes a risk of the decline of a printing operation or efficiency. Furthermore, when the printed marker is optically read, a printed image using inks of a plurality of colors interferes with the marker to thereby suppress the reproducibility of the marker of a single color. This consequently may cause a risk of the decline of the accuracy at which the conveying amount of the printing medium is determined (and thus the decline of the accuracy at which the deviation of the image printing position is corrected).

### SUMMARY OF THE INVENTION

The present invention provides a printing apparatus and a printing method that can use, while providing the entire printing apparatus having a simpler and smaller configuration, information printed on a printing medium to control the printing of the image.

In the first aspect of the present invention, there is provided a printing apparatus for printing an image on a printing medium conveyed in a conveying direction using a plurality of color materials including chromatic material and achromatic material, comprising:

a first printing unit configured to use at least one of the chromatic materials to print, on the printing medium, an image including information used to control the printing,

a second printing unit configured to use the achromatic material to print an image on the printing medium,

a reading unit configured to read the information, and

a printing control unit configured to calculate, based on the information read by the reading unit, a conveying amount of the printing medium to perform a printing control,

wherein:

the reading unit is positioned at a downstream side of the conveying direction than the first printing unit and at a upstream side in the conveying direction than the second printing unit.

In the second aspect of the present invention, there is provided a printing method for printing an image on a printing medium conveyed in a conveying direction using a plurality of color materials including chromatic material and achromatic material, comprising:

a first printing step of using at least one of the chromatic materials to print, on the printing medium, an image including information used to control the printing,

a second printing step of using the achromatic material to print an image on the printing medium,

a reading step of reading the information after the first printing step and before the second printing step, and

a printing control step of calculating, based on the information read by the reading unit, a conveying amount of the printing medium to perform a printing control.

According to the present invention, by allowing an image printed by chromatic material to include information used to control the printing, the entire printing apparatus can have a simpler and smaller configuration without requiring a special configuration to print the information. Furthermore, the image printed by the chromatic material is read and an image is subsequently printed on a printing medium by achromatic material. Thus, the information included in the image printed by the chromatic material can be read without being influenced by the achromatic material. For example, when the information includes information regarding the conveying amount of the printing medium, the deviation of the image printing position for example can be appropriately corrected based on this information.

Further features of the present invention will become apparent from the following description of exemplary embodiments (with reference to the attached drawings).

### BRIEF DESCRIPTION OF THE DRAWINGS

FIG. 1 is a perspective view illustrating the appearance of a printing apparatus in the first embodiment of the present invention;

FIG. 2A is a plan view illustrating a printing unit in FIG. 1;

FIG. 2B is a side view illustrating the printing unit;

FIG. 3A is a plan view illustrating a sensor unit in FIG. 2A;

FIG. 3B is aside view illustrating the sensor unit;

FIG. 4 illustrates the optical characteristic of the sensor unit;

FIG. 5 illustrates the reflectance spectrum of ink;

FIG. 6A illustrates an example of dot formation positions;

FIG. 6B, FIG. 6C, and FIG. 6D illustrate dot reading signals transmitted through R (red), G(green), and B(blue) filters, respectively;

FIG. 7A illustrates another example of dot formation positions;

FIG. 7B, FIG. 7C, and FIG. 7D illustrate dot reading signals transmitted through the R (red), G(green), and B(blue) filters, respectively;

FIG. 8 is a block diagram illustrating the configuration of a printing system;

FIG. 9 is a block diagram illustrating the feedback control in the printing apparatus;

FIG. 10 is a block diagram illustrating the configuration of the quantization unit of FIG. 9;

FIG. 11 is a flowchart illustrating a quantization processing;

FIG. 12 illustrates an electronic watermark superimposed region on a sheet;

FIG. 13A illustrates a quantization condition A;

FIG. 13B illustrates a quantization condition B;

FIG. 14 is a block diagram illustrating a conveying amount guessing unit in FIG. 5;

FIG. 15 illustrates a blocked processing of a read image;

FIG. 16A illustrates a space filter A;

FIG. 16B illustrates a space filter B;

FIG. 17 illustrates a two-dimensional frequency region;

FIG. 18 is a flowchart illustrating a decoding processing of an electronic watermark;

FIG. 19 illustrates a culling method in a culling unit A;

FIG. 20 illustrates a culling method in a culling unit B;

FIG. 21 illustrates an estimate method of a boundary part;

FIG. 22 illustrates the configuration of a printing unit in the second embodiment of the present invention;

FIG. 23 illustrates the configuration of the printing unit in the third embodiment of the present invention;

FIG. 24A illustrates an example of a dot formation position in the fourth embodiment of the present invention;

FIG. 24B and FIG. 24C illustrate the output 1 and the output 2 from a density calculator, respectively;

FIG. 25 illustrates the configuration of the printing unit in the fourth embodiment of the present invention;

FIG. 26 illustrates a printing example of a visible marker in the fifth embodiment of the present invention; and

FIG. 27 illustrates a photographed image by the sensor unit in FIG. 2A.

### DESCRIPTION OF THE EMBODIMENTS

The following section will describe embodiments of an inkjet printing apparatus. The printing apparatus of this example is a full line-type inkjet printing apparatus in which inks of a plurality of colors are ejected from long inkjet printing heads (line heads) while continuously conveying a continuous sheet as a printing medium to thereby print an image. Such a printing apparatus is preferably used in a print laboratory in which many images are printed at a high speed for example.

### First Embodiment

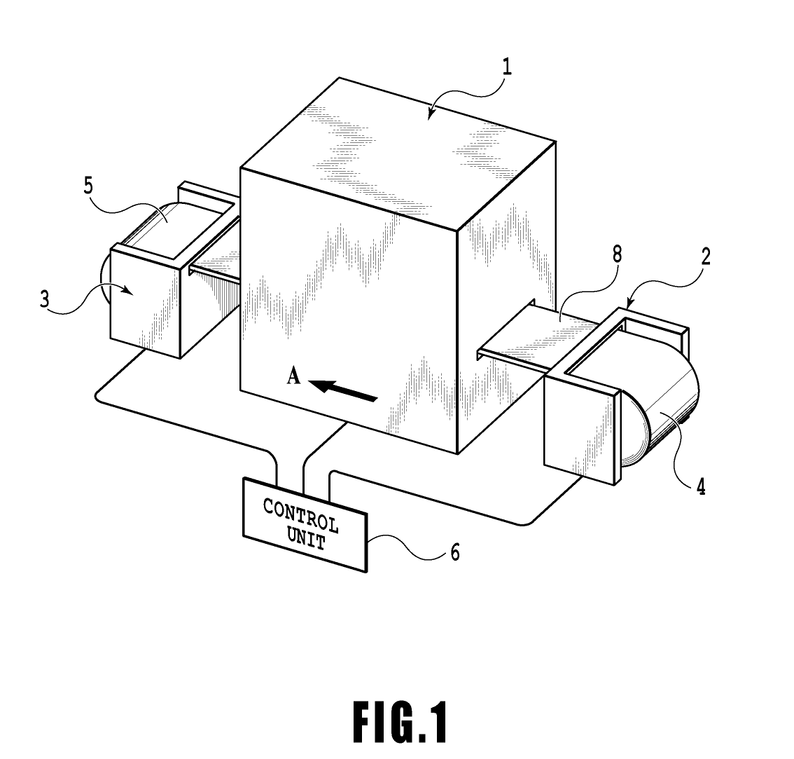

FIG. 1 illustrates the appearance of the printing apparatus in this embodiment. The printing apparatus has a printing unit 1, a sheet supply unit 2, and a sheet winding unit 3. The sheet supply unit 2 retains a roll sheet 4 obtained by winding a continuous sheet (printing medium) 8 and supplies the sheet 4 to the printing unit 1 while feeding the sheet 8. The printing unit 1 sequentially prints a plurality of images onto the sheet 8. The sheet 8 on which images are printed is wound as a roll sheet 5 by the sheet winding unit 3. With regard to an arbitrary position within a conveying path of the sheet 8, a side closer to the sheet supply unit 2 is represented as “upstream side” while an opposite side is represented as “downstream side”.

### (Outline of the Configuration of the Printing Apparatus)

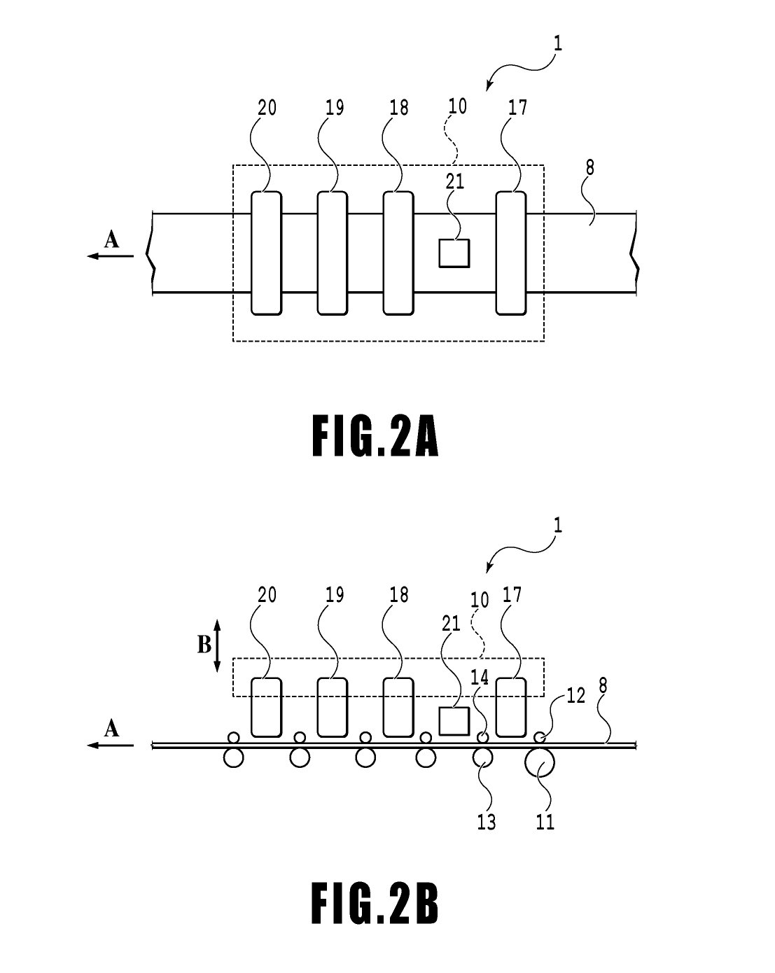

FIG. 2A and FIG. 2B illustrate the configuration of the interior of the printing unit 1. FIG. 2A is a plan view of the printing unit 1. FIG. 2B is a side view thereof. The continuous sheet 8 supplied from the sheet supply unit 2 to the printing unit 1 is continuously supplied in the printing unit 1 in a direction shown by an arrow A. A sheet convey mechanism in the printing unit 1 is a main conveying roller pair composed of a conveying roller as a driving roller, a pinch roller 12 as a driven roller. This main conveying roller pair maintains the accuracy at which the sheet 8 is conveyed. The printing unit 1 includes printing heads 17, 18, 19, and 20 through which yellow, black, cyan, and magenta inks can be ejected. The downstream side of these printing heads has the total of five pairs of sub conveying rollers each of which is composed of a convey roller 13 as a driving roller and a pinch roller 14 as a driven roller.

Each printing head is a long inkjet line head extending for the maximum printing width of the sheet 8 to be used and is formed so that a nozzle line is formed for the entire maximum printing width of the sheet 8 by nozzles through which ink can be ejected. The nozzle line is formed to extend in a direction intersecting (crossing at light angle in this example) with a direction (the direction shown by the arrow A) along which the continuous sheet 8 is conveyed. The inkjet method is a method according to which an ejection energy generating element (e.g., an electrothermal transducing element (heater), a piezo element, an electrostatic element, or an MEMS element) is used to eject ink through an ejection opening at a tip end of a nozzle. Inks of the respective colors are supplied from the respective ink tanks via ink tubes to the corresponding printing heads. The number of the colors of inks and the number of the printing heads are not limited to four and may be a larger or smaller number. The printing head also may be integrated with an ink tank storing ink of the corresponding color to provide a unit.

Each printing head is retained by a head holder 10. The head holder 10 is raised or lowered by a driving mechanism (not shown) in a direction shown by an arrow B for the purpose of a maintenance operation. A sensor unit 21 optically photographs printed information printed on the sheet 8. By analyzing the photographed information, a travel amount and a travel speed of the sheet 8 for example can be detected as described later. The sensor unit 21 is provided at the downstream side of the printing head 17 for ejecting yellow ink and at substantially the center of the sheet 8 in the width direction. By providing the sensor unit 21 in the manner as described above, the sheet 8 also can be subjected to a margin-less printing (full printing) including no blank margin. Furthermore, the sensor unit 21 is suppressed from being influenced by ink mist caused by the printing head. Thus, even when the sheet 8 is minutely meandering and slightly inclined, an average conveying amount can be detected. The sheet 8 is conveyed in the conveying path as described above in the direction shown by the arrow A to thereby sequentially print an image using inks of yellow, black, cyan, and magenta.

### (Sensor Unit)

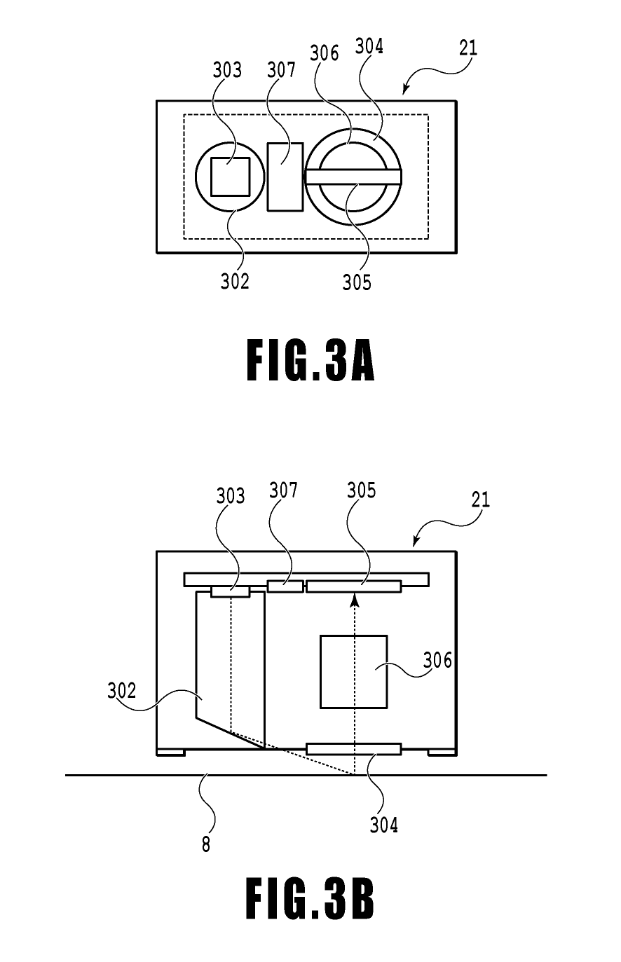

FIG. 3A and FIG. 3B illustrate the sensor unit 21. FIG. 3A is a plan view of the sensor unit 21. FIG. 3B is a cross-sectional view illustrating the sensor unit 21 seen from a side. The sensor unit 21 is mainly composed of a light-emitting unit, a light-receiving unit, and an image processing unit that are integrated as a unit. Alight source 303 is a light-emitting element such as LED, OLED, or semiconductor laser. Light emitted from the light source 303 is guided by a light guiding structure 302 to irradiate the surface of the sheet 8 in an inclined direction. An image in the light-irradiated region on the sheet 8 is imaged on an image sensor 305 by a lens 306. A transparent protection cover 304 prevents a situation in which ink mist for example enters from the side of the sheet 8 and is attached to the lens 306. The image sensor 305 has a configuration in which many photoelectric conversion elements of a CCD or CMOS structure are arranged in a one-dimensional manner or an area image sensor in which these photoelectric conversion elements are arranged in a two-dimensional manner. This image sensor 305 is configured, as described later, to simultaneously read a predetermined range of an image printed on the sheet 8 by yellow ink with a predetermined time interval.

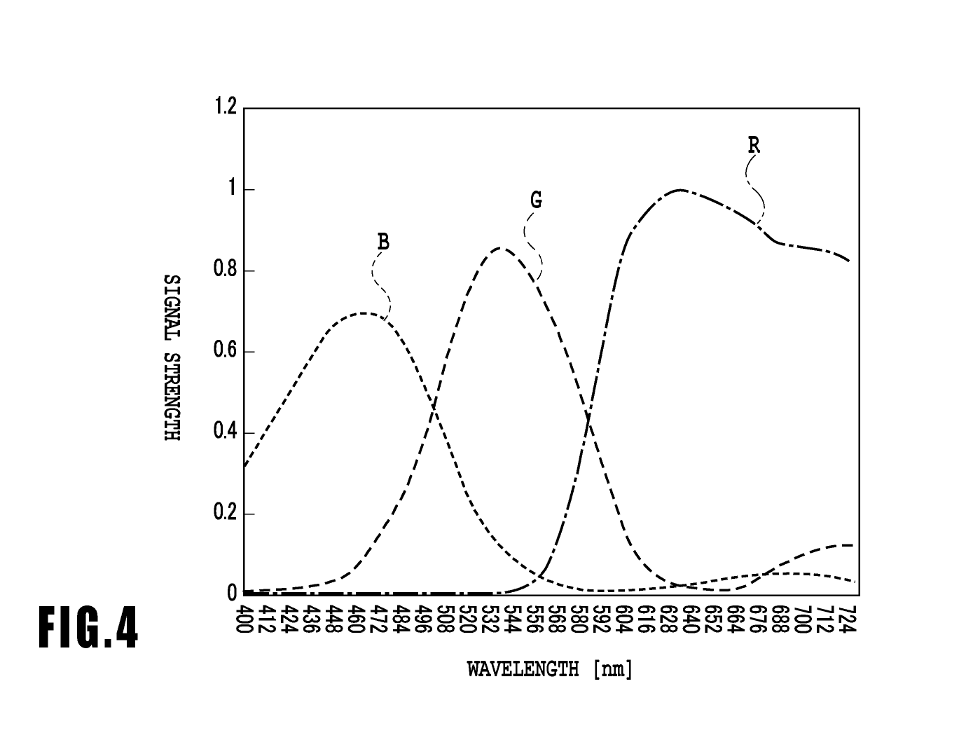

FIG. 4 illustrates the optical characteristic of the sensor unit 21. Light spectroscopy methods include an irradiation light spectroscopy method to change a light source and a reflection light spectroscopy method to use a filter. The sensor unit 21 may be based on any of these methods. The following section will describe a case where the sensor unit 21 based on the reflection light spectroscopy method is used. The sensor unit 21 is configured to read a signal subjected to the spectroscopy by an RGB filter (not shown).

FIG. 4 illustrates an example in which the wavelength [nm] is represented on the horizontal axis and the signal strength normalized at the maximum value is represented on the vertical axis. In FIG. 4, the curves R, G, and B represent signals subjected to the spectroscopy by the respective R (red), G(green), and B(blue) filters when the light source 303 has a characteristic indicated by S(λ).

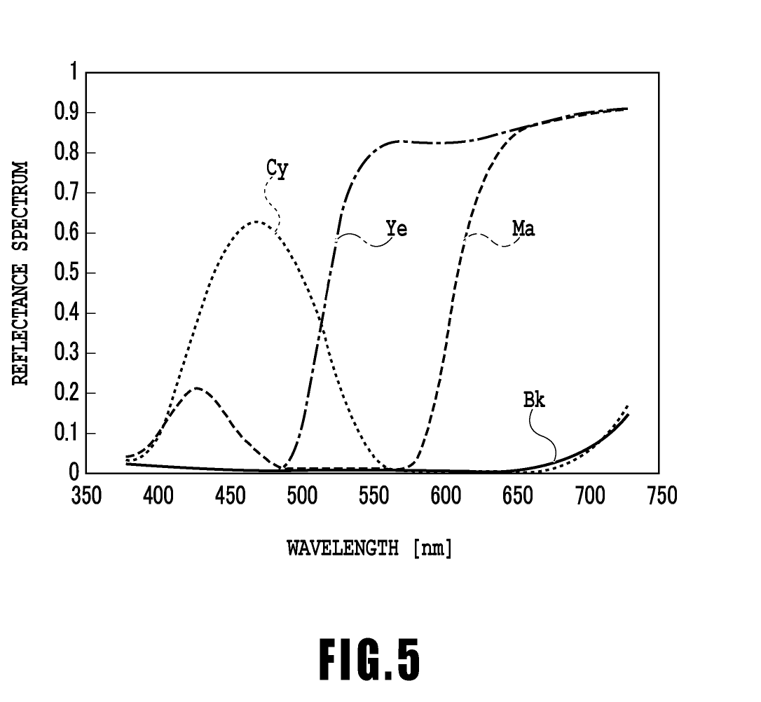

As shown in FIG. 5, the cyan ink has the reflectance spectrum Cy for which the high wavelength region is at the bottom and the high wavelength region of the incident light is absorbed to provide a low signal component. Due to this characteristic, the signal component in the high wavelength region changes depending on the existence or nonexistence of cyan ink. Thus, the existence or nonexistence of cyan ink can be determined by analyzing the signal component transmitted through the R(red) filter having sensitivity in the high wavelength region. Similarly, based on the characteristic of the reflectance spectrum Ma of the magenta ink, the existence or nonexistence of magenta ink can be determined by analyzing the signal component transmitted through the G(green) filter. Furthermore, based on the characteristic of the reflectance spectrum Ye of yellow ink, the existence or nonexistence of yellow ink can be determined by analyzing the signal component transmitted through the B(blue) filter. The reflectance spectrum Bk is the reflectance spectrum of black ink.

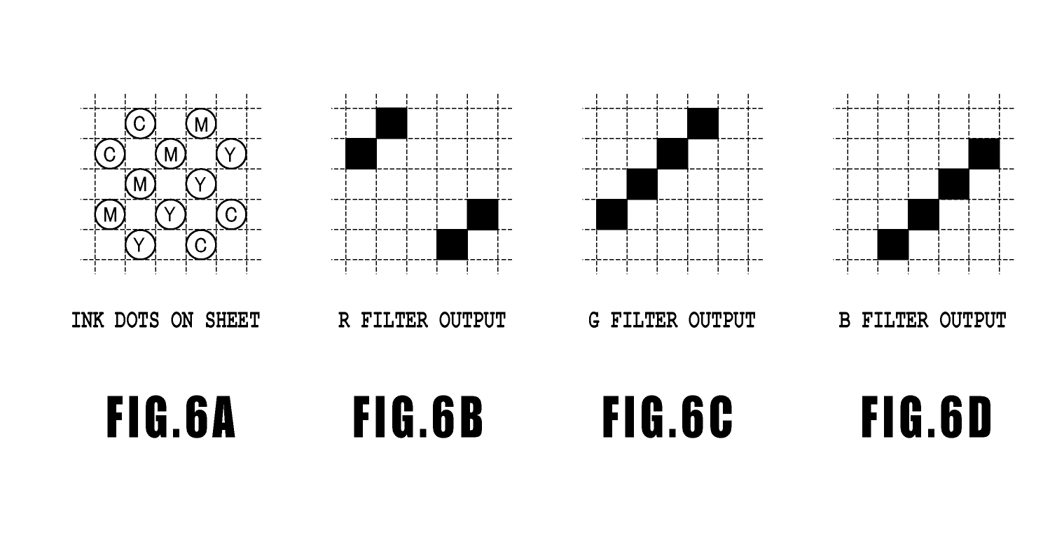

FIG. 6A, FIG. 6B, FIG. 6C, and FIG. 6D illustrate an example of the signal output after an operation to use the sensor unit 21 to read ink dots formed on the sheet 8 and the read signals are transmitted through the R (red), G(green), and B(blue) filters. FIG. 6A shows the cyan ink dots (cyan dots) C, magenta ink dots (magenta dots) M, and yellow ink dots (yellow dots) Y formed on the sheet 8. FIG. 6B, FIG. 6C, and FIG. 6D show the output of signals transmitted through the R (red), G(green), and B(blue) filters, respectively. For the convenience of description, the dot size and the reading resolution of the sensor unit 21 are treated equally.

The output transmitted through the R filter has, due to the absorption of the incident light at the position of the cyan dot C, a lowered output of a part corresponding to the position (which is shown by black in the drawing) and a higher output of parts corresponding to the other positions (which is shown by white in the drawing). Based on this result, the position of the cyan dot C can be identified. Similarly, the magenta dot M can be identified by using the G filter as shown in FIG. 6C. The yellow dot Y can be identified by using the G filter as shown in FIG. 6D. Furthermore, a dot pattern including the mixture of the respective dots C, M, and Y also can be handled by separating the respective dots because different filters are used for the analysis of the respective dots. Furthermore, when only dots of a specific color ink are desired to be analyzed, then only the output result of a filter corresponding to the ink color may be analyzed.

FIG. 6A, FIG. 6B, FIG. 6C, and FIG. 6D illustrate an example in which inks of cyan, magenta, and yellow are used. When black ink is used in addition to these inks, a method of identifying dots of the black ink is different from those for dots of other inks. The black ink has a low reflectance spectrum in the entire wavelength region as shown in FIG. 5. Based on the characteristic as described above, black ink can be analyzed based on signal components transmitted through all of the filters. However, when dots of black ink are mixed, the analysis of a dot pattern of the other ink colors results, due to the light absorption by black ink, signals transmitted through the respective filters always have a small output.

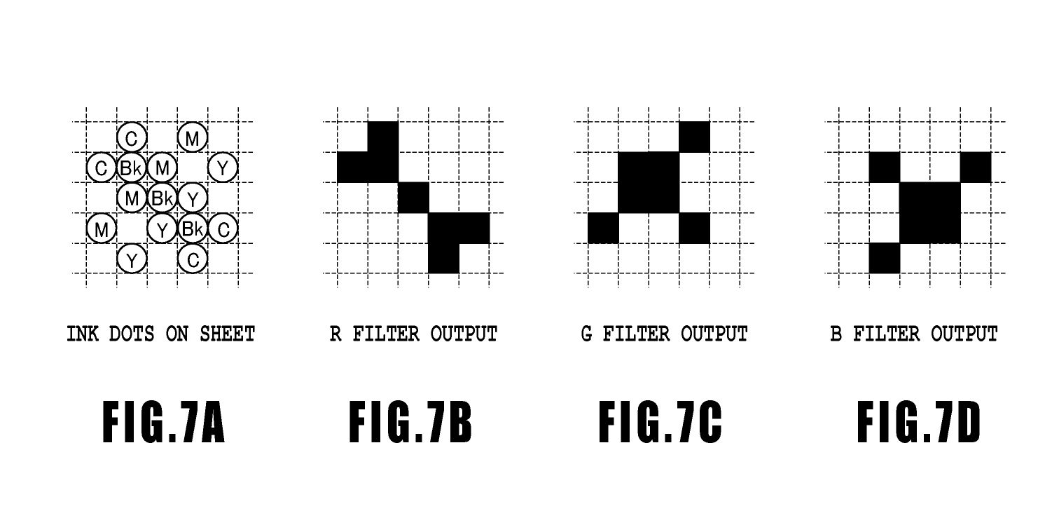

When black ink dots (black dot) Bk are mixed as shown in FIG. 7A, then signals transmitted through the R (red), G(green), and B(blue) filters are as shown in FIG. 7B, FIG. 7C, and FIG. 7D. The reading signal of the black dot Bk has a low output when passing through any filter. Thus, the output of the R filter of FIG. 7B has a low output of parts corresponding to the positions of cyan and black ink dots C and Bk. Thus, the output of the R filter as described above cannot be used as a ground to determine the cyan ink dot C and the black ink dot BK. The same applies to the outputs of the G filter and B filter of FIG. 7C and FIG. 7D.

In the examples of FIG. 7A, FIG. 7B, FIG. 7C, and FIG. 7D, a part having a low output part common in the output signals from the respective filters can be searched to estimate that the position corresponding to this part includes the black dot BK. However, since an actual image printing is frequently involved with superimposed dots of inks of a plurality of colors, it is difficult to determine the dots of the respective inks. This means that the analysis of a dot pattern including achromatic black ink is difficult.

From such a viewpoint, in this embodiment, electronic watermark information by which space information can be detected is superimposed on printing data for ejecting yellow ink to print information using only chromatic yellow ink in order to detect the sheet conveying amount, as described later.

Specifically, as described later, an image to be printed by yellow ink is divided to a plurality of blocks. Two different pieces of electronic watermark information are superimposed on the respective blocks to subsequently print the image. The two-dimensional image sensor 305 instantly and simultaneously reads the predetermined range of the printed image at a predetermined time interval.

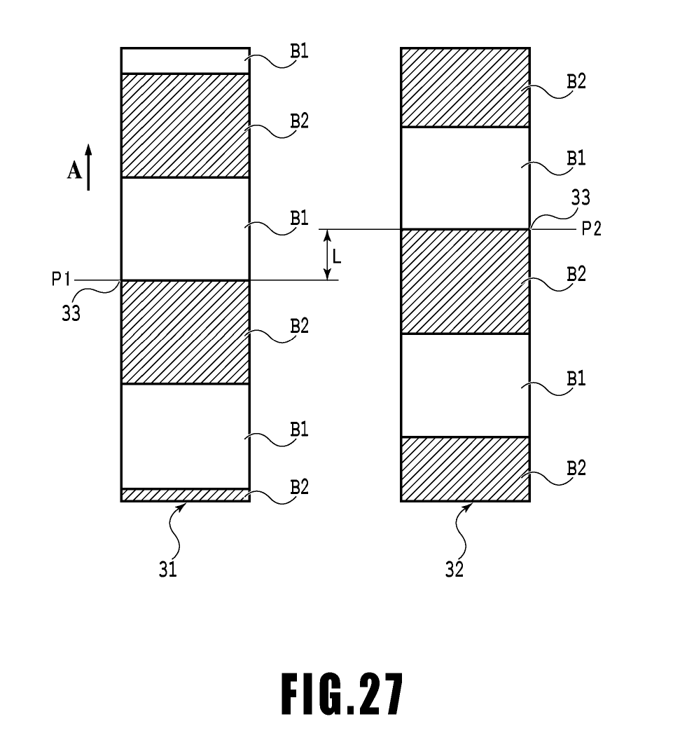

FIG. 27 illustrates a photographed image by the image sensor 305. The sheet 8 is conveyed in the direction shown by the arrow A while an image in which electronic watermark information is embedded is printed thereon by yellow ink. The image sensor 305 photographs the predetermined range of the printed image at a different timing. In FIG. 27, an image 31 is an image photographed by the image sensor 305 at a certain time and an image 32 is an image photographed after the sheet 8 is conveyed in the direction shown by the arrow A over a fixed time after the image 31 is photographed.

As described later, an image to be printed by yellow ink is divided to a plurality of blocks. In the blocks arranged in the direction shown by the arrow A, different pieces of electronic watermark information are alternately embedded depending on two different types of image processings. In FIG. 27, a block B1 is an image region in which electronic watermark information is embedded by one image processing while a block B2 is an image region in which electronic watermark information is embedded by the other image processing. These blocks B1 and B2 include therein different pieces of electronic watermark information. Thus, these pieces of electronic watermark information are printed so as to correspond to the blocks. As described later, a boundary part 33 between the blocks B1 and B2 is sensed to calculate a distance L between a position P1 at which the boundary part 33 exists in the photographed image 31 and a position P2 at which the boundary part 33 exists in the photographed image 32. Based on the number of pixels positioned within the distance L, the conveying amount of the sheet 8 within a fixed period of time can be calculated.

For example, after the photographed image 31 is acquired at a certain time T, then the photographed image 32 is acquired at a timing at which the predetermined time T1 has passed. By sensing the boundary part 33, it is possible to determine that the photographed boundary part 33, which has been provided at the position P1 within the image 31, has moved to the position P2 within the photographed image 32. When an ideal conveying distance of the sheet 8 (conveying amount) at the predetermined time T1 is 800 μm and the distance L is 810 μm, it means that the difference of 10 μm therebetween causes a proportional increase of the conveying amount of the sheet 8 at the predetermined time T1 (i.e., a proportional increase of the conveying speed). This speed difference of 10 μm is fed back in order to control the conveying amount of the sheet 8. During the printing of the image, the feedback control as described above is repeated.

### (Configuration of Control System)

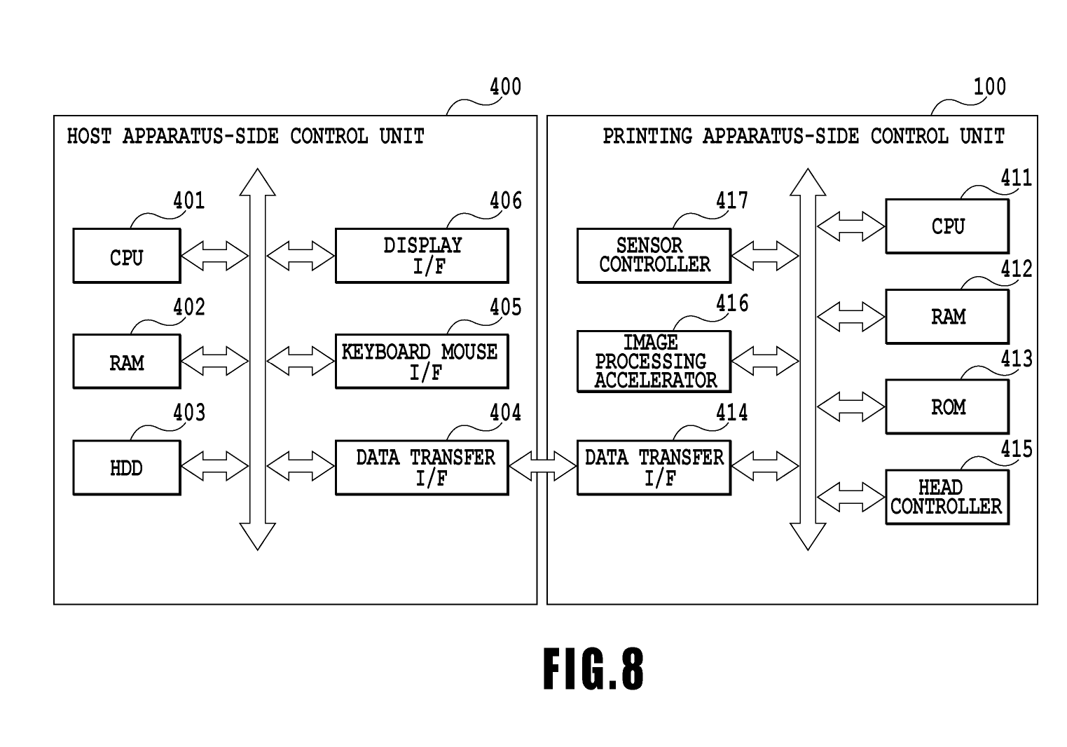

FIG. 8 is a block diagram illustrating a configuration of a control system in the printing apparatus of this embodiment. The control system of this example includes a system control unit 100 of the printing apparatus in FIG. 1 and a system control unit 400 as a personal computer functioning as a hos apparatus thereof.

In the host apparatus-side control unit 400, a CPU 401 executes various processings in accordance with programs retained in a HDD 403 and RAM 402. The RAM 402 is a volatile storage to temporarily retain a program or data. The HDD 403 is a nonvolatile storage to similarly retain a program or data. A data transfer I/F (interface) 404 controls data transmission/reception with the printing apparatus-side control unit 100. This data transmission/reception method may use USB, IEEE1394, or LAN for example. A keyboard/mouse I/F 405 is an I/F that controls a HID (HUMAN INTERFACE DEVICE) such as a keyboard or a mouse. A user can input various pieces of information via this I/F 405. A display I/F 406 controls a display (not shown).

On the other hand, in the printing apparatus-side control unit 100, a CPU 411 executes various processings including processings described later in accordance with programs retained in a ROM 413 or RAM 412. The RAM 412 is a volatile storage that temporarily retains a program or data. The ROM 413 is a nonvolatile storage that can retain various pieces of table data and programs. A data transfer I/F 414 controls data transmission/reception with the host apparatus-side control unit 400. A head controller 415 supplies, to the printing heads 17, 18, 19, and 20 of FIG. 2A, printing data decomposed to correspond to these respective corresponding ink colors and controls the ink ejection operations in these printing heads. Specifically, the head controller 415 reads control parameter and printing data from a predetermined address of the RAM 412. When the CPU 411 writes the control parameter and printing data to the predetermined address, the head controller 415 is activated to allow, based on these control parameter and printing data, ink to be ejected through the printing heads 17, 18, 19, and 20. An image processing accelerator 416 is constituted by a hardware and executes an image processing at a higher speed than that of the CPU 411. Specifically, the image processing accelerator 416 reads the parameter and data required for the image processing from the predetermined address of the RAM 412. When the CPU 411 writes the parameter and data to the predetermined address, the image processing accelerator 416 is activated and the predetermined image processing is carried out.

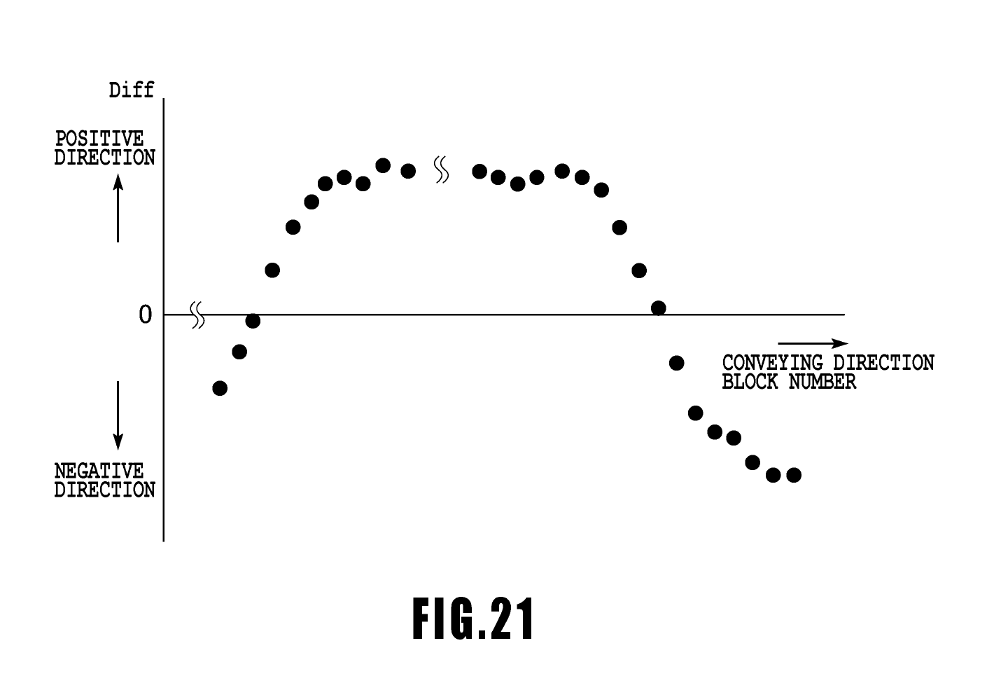

A sensor controller 417 is a controller that controls the sensor unit 21 of FIG. 21. An image signal photographed by the image sensor 305 is transmitted to the CPU 411. In this example, the image signal is subjected to an image analysis processing to detect information regarding the conveyance of the sheet 8 (e.g., travel amount, travel speed, travel acceleration, or travel direction). In this analysis processing, a partial processing requiring a high speed is executed by the image processing accelerator 416. The detected information regarding the conveyance of the sheet 8 (travel information) is sent to the head controller 415. The head controller 415 subjects the ink ejection timing in the printing head to a feedback control depending on the conveying amount of the sheet 8. Specifically, when it is determined that the conveying speed of the sheet 8 is slower than an anticipated speed, the ink ejection timing is delayed. When it is determined that the conveying speed of the sheet 8 is faster than the anticipated speed on the other hand, the ink ejection timing is brought forward. This can consequently maintain a fixed relative positional relationship between the sheet 8 and the printing position.

In this embodiment, printing data for printing an image on the sheet 8 is superimposed with information regarding the conveying amount of the sheet 8 (the information used to print the image) by an electronic watermark, thereby the image in which the information is embedded as an invisible mark is printed. Then, the printed image is read by the image sensor. From among the read data, the information embedded by the electronic watermark is decoded. Based on the analysis result thereof, the ink ejection timing is adjusted. The electronic watermark is a collective term meaning a method of changing image information or a printing process to embed the information in an actual image. Here, the electronic watermark does not include, in addition to the change of the image information and printing process, a method of physically or chemically changing a printing medium for example to embed information.

### (Superimposition of Electronic Watermark)

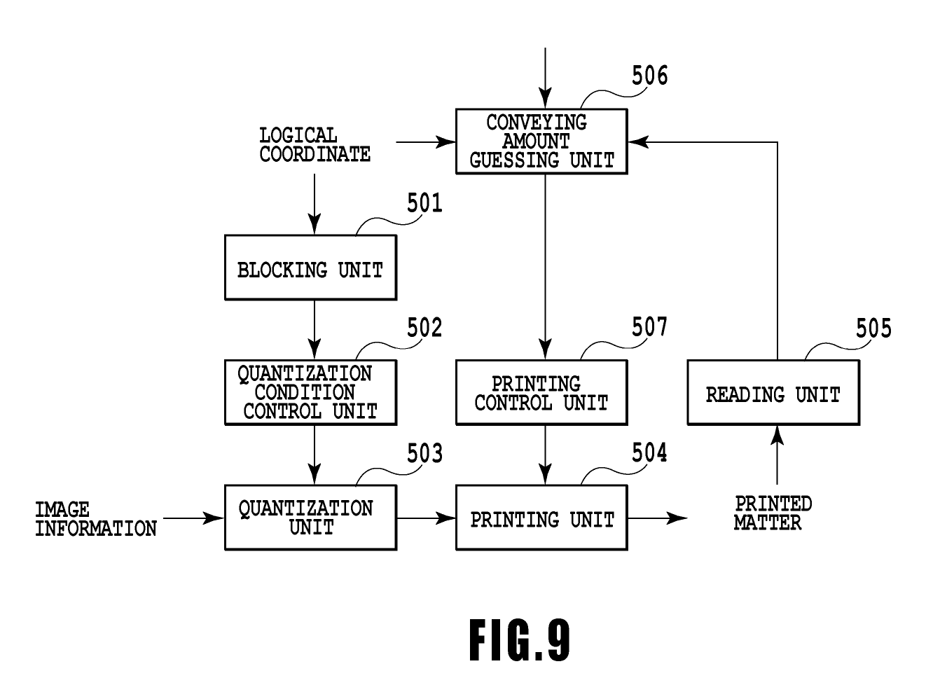

FIG. 9 is a block diagram illustrating a configuration of a control unit that prints an image in which information regarding the conveying amount of the sheet 8 is embedded by an electronic watermark, reads the printing result, analyzes the result, and performs a feedback control based on the analysis result. In this example, within an image printed by yellow ink, information regarding the conveying amount of the sheet 8 is embedded by an electronic watermark. Then, as described later, the printed image using yellow ink is read. Based on the analysis result of the information embedded in the image, the conveyed distance (conveyed amount) of the sheet 8 is guessed.

A blocking unit 501 divides, based on an inputted logical coordinate, an actual image to be printed based on printing data into blocks by a predetermined pixel unit. A form of such a block may be a rectangle or other than the rectangle. That is, this conversion to blocks may use a rectangle or also may use a region other than a rectangle for classification. The logical coordinate is a coordinate of the logical printing position of the image on the sheet 8 and is a coordinate that does not consider a mechanical, electrical, physical, or chemical variation in the printing process (e.g., a change of contraction or conveying amount of the sheet 8). A quantization condition control unit 502 controls a quantization condition in a quantization unit 503 based on the blocked predetermined pixel unit. The quantization unit 503 subjects the inputted image information (image data) to a pseudo gradation processing based on the error diffusion method to thereby generate printing data has a quantization level lower than the inputted gradation number of the image information.

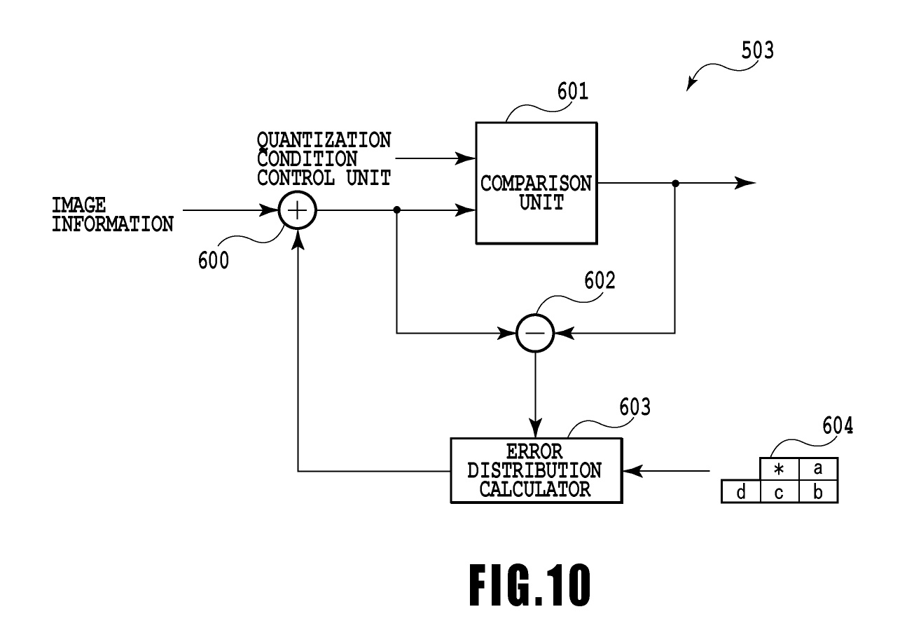

FIG. 10 is a block diagram illustrating the details of the quantization unit 503. A general error diffusion processing is disclosed in the following publication: R. FLOYD & L. STEINBERG: “AN ADAPTIVE ALOGORITHM FOR SPATIAL GRAYSCALE”, SID SYMPOSIUM DIGEST OF PAPER, pp. 36 to 37 (1975). The following section will describe an error diffusion processing having a binary quantization value.

An adder 600 adds a target pixel value of the inputted image information and a distributed quantization error of an already-binarized peripheral pixel. A quantization threshold value of the quantization condition control unit 502 and the addition result by the adder 600 are compared by a comparison unit 601. When the addition result by the adder 600 is higher than the quantization threshold value, “1” is outputted. In the cases other than the above case, “0” is outputted. For example, when the pixel gradation is expressed by 8 bits, the binary expression is generally provided by the maximum value “255” and the minimum value “0”. When the quantization value is “1”, dots are formed on the sheet 8 using ink or toner for example. A subtractor 602 calculates an error between the quantization result and the addition result by the adder 600 and an error distribution calculator 603 distributes the error to peripheral pixels to be subjected the quantization processing later. The error is distributed based on a rate of the error distribution set in an error distribution table 604. The distribution table 604 is provide in advance in which the rate of the error distribution is experimentally set based on the relative distance between the target pixel and the peripheral pixel. The distribution table 604 in FIG. 10 is a distribution table for four pixels surrounding the target pixel but the invention is not limited to this.

### (Quantization Processing)

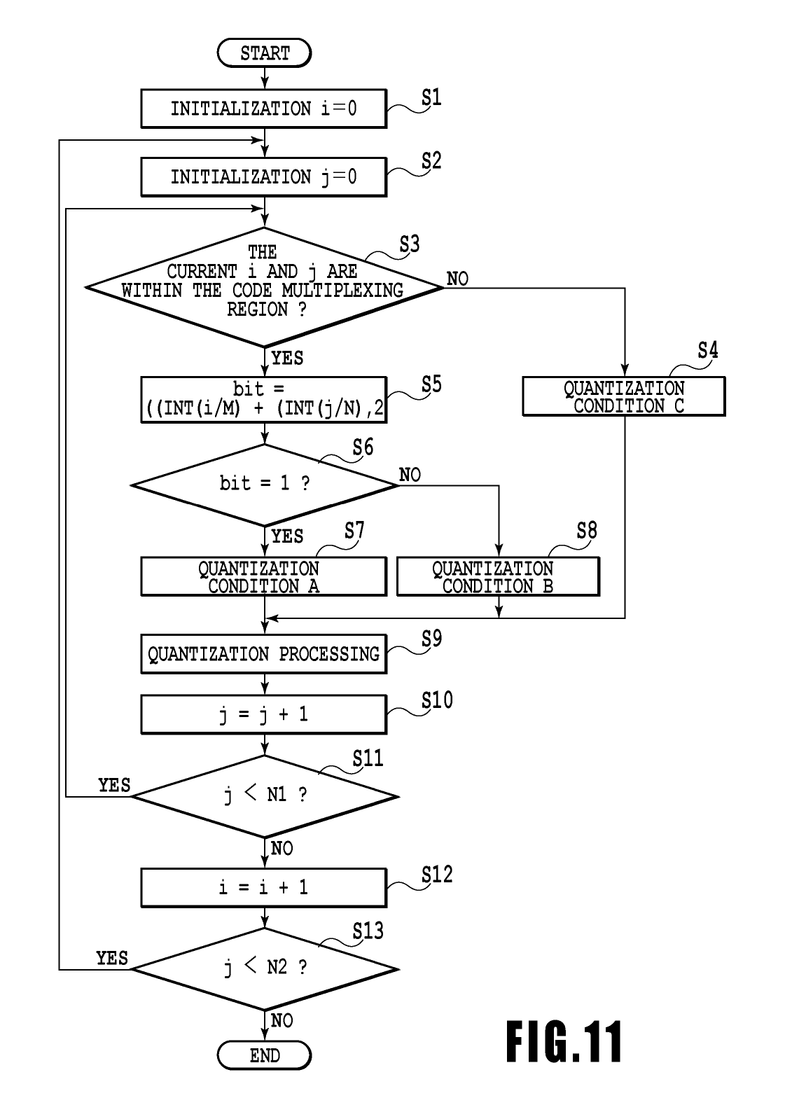

FIG. 11 is a flowchart illustrating the setting of the quantization condition by the quantization condition control unit 502 and the quantization processing. In this example, a quantization value is binary.

First, in step S1, a variable i is initialized. The variable i is a variable to count the address in the vertical direction. Next, in step S2, a variable j is initialized. The variable J is a variable to count the address in the horizontal direction. Next, in step S3, based on the address values of i and j, it is determined whether the coordinates of i and j as a current processing address belong to a region to be subjected to an electronic watermark superimposition processing (electronic watermark superimposed region) or not.

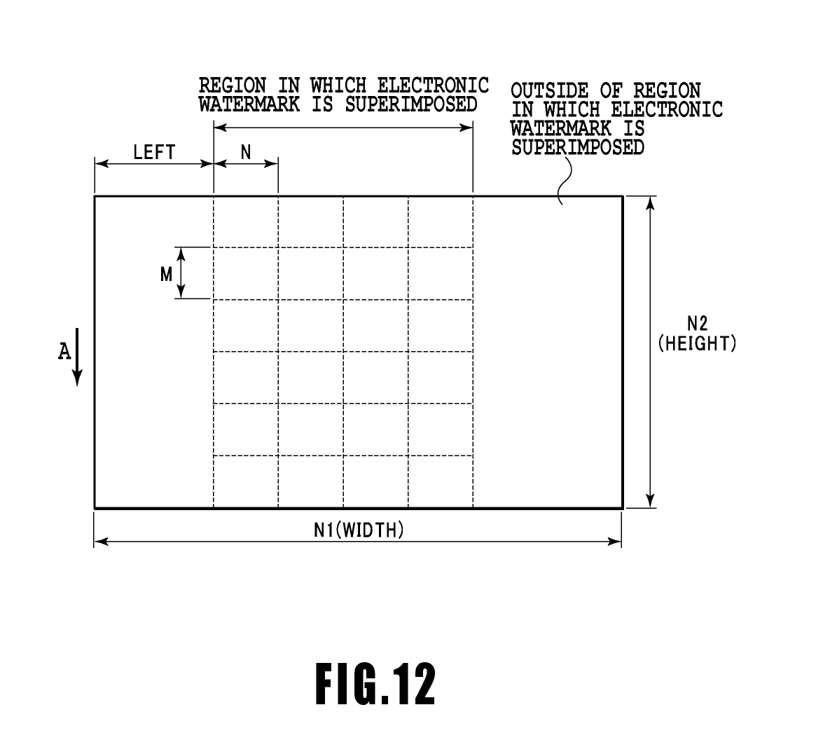

FIG. 12 is a figure for explaining the electronic watermark superimposed region. FIG. 12 illustrates a printed image for which the pixel number in the horizontal direction (WIDTH direction) is N1 and the pixel number in the vertical direction (HEIGHT direction) is N2. It is assumed that this printed image is arranged over the entire surface of the sheet 8. The information regarding the conveying amount of the sheet 8 is embedded in this printed image by the electronic watermark. In this example, since the sensor unit 21 is positioned at substantially the center in the width direction of the sheet 8 as shown in FIG. 2A, the electronic watermark superimposed region in which the information is embedded by the electronic watermark is positioned at the center in the width direction of the sheet 8. A logical horizontal coordinate at the left end of the electronic watermark superimposed region is assumed as LEFT. As shown by the broken line, the electronic watermark superimposed region at the right side of the coordinate LIEFT is converted to blocks of lateral N pixels and longitudinal M pixels, respectively. The coordinate LEFT is preferably an integral multiple of N.

In step S3 of FIG. 11, when it is determined that the currently-processed target pixel is at the exterior of the electronic watermark superimposed region (code multiplexing region), that is at a region exterior to the broken line block in FIG. 12, step S4 sets a quantization condition C. On the other hand, when it is determined that the currently-processed target pixel is within the electronic watermark superimposed region (code multiplexing region), that is within a region within the broken line block in FIG. 12, the electronic watermark information is superimposed in order to identify the block position. In order to determine a boundary between blocks on which electronic watermark information is superimposed, a variable BIT coding these blocks is calculated by the following formula (1) (step S5).

BIT=MOD((INT(i/M)+INT(j/N)),2) (1)

INT(i/M) means an integer part of (i/M). INT(j/N) means an integer part of (j/N). Thus, INT (i/M) shows the order at which a certain block exists in a printed image. INT(j/N) shows the order at which a certain block exists in the printed image. Furthermore, MOD((INT(i/M)+INT(j/N)), 2) means the remainder when (JINT(i/M)+INT(j/N)) is divided by 2.

The variable BIT is a remainder obtained when the integer is divided by 2. Thus, the variable BIT has a value of “0” or “1”. When step S6 determines that the variable BIT is “0”, step S7 sets the quantization condition A. When step S6 determines that the variable BIT is “1” on the other hand, step S8 sets the quantization condition B. Next, step S9 subjects, based on quantization condition A or B set in the manner as described above, the image information of the yellow ink to a quantization processing. This quantization processing corresponds to the error diffusion described in FIG. 10.

Next, step S10 increments the variable j in the horizontal direction and determines whether or not the count number j is smaller than N1 representing the number of pixels of the printed image in the horizontal direction (step S11). Until the count number reaches N1, the processing from step S3 to step S10 are repeated. When the count number j reaches N1, then step S12 increments the variable i in the vertical direction and determines whether or not the count number i is smaller than N2 representing the pixel number of the printed image in the vertical direction (step S13). Until the count number i reaches N2, the processing from step S2 to step S12 are repeated.

By the operation procedure as described above, the quantization conditions can be changed based on a block unit consisting of (N×M) pixels. When the above formula (1) is used to calculate the variable BIT, a plurality of blocks shown by the broken line in FIG. 12 are configured so that blocks corresponding to the quantization condition A and blocks corresponding to the quantization condition B are arranged in a staggered manner.

### (Quantization Condition)

Next, examples of the quantization conditions A, B, and C will be described.

The quantization conditions in the error diffusion include various factors. However, in this example, a quantization threshold value is set as a quantization condition. The quantization condition C is used at the exterior of the electronic watermark superimposed region. Thus, an arbitrary quantization threshold value may be used. As described earlier, in the gradation expression in which one pixel is represented by 8 bits, when the quantization level is binary, then the maximum value “255” and the minimum value “0” are used as typical quantization values and the intermediate value thereof of “128” is frequently set as a quantization threshold value. Thus, in the quantization condition C of this example, the quantization threshold value is set to “128”.

The quantization condition A and the quantization condition B are used in a block within the electronic watermark superimposed region. Thus, the quantization condition A and the quantization condition B are different conditions so as to cause a difference in the image quality. The difference in the image quality must be expressed so as to be suppressed from visually recognized and to be easily identified by the sensor unit 21.

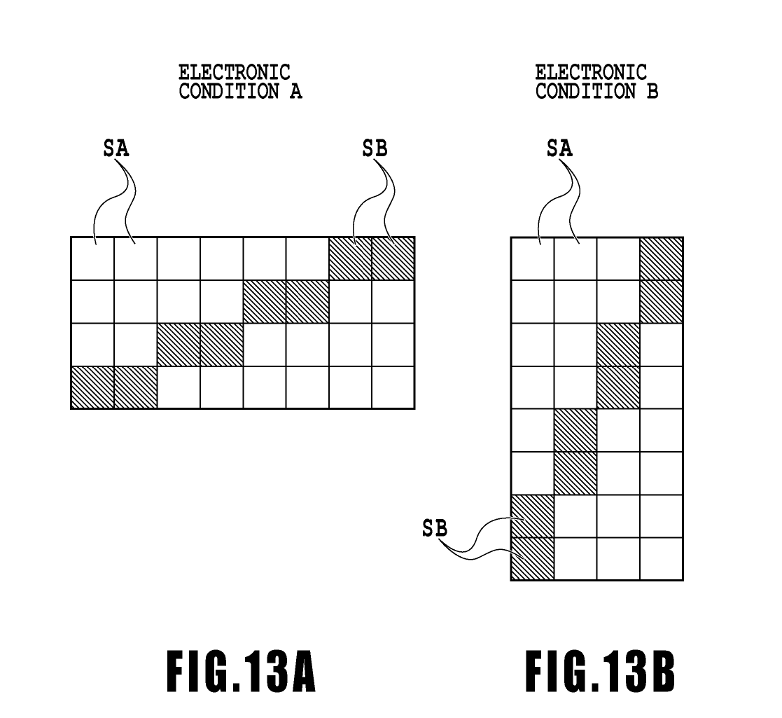

FIG. 13A and FIG. 13B illustrate the quantization conditions A and B. FIG. 13A shows a cycle of the change of the quantization threshold value in the quantization condition A. In the drawing, one cell is assumed as corresponding to one pixel and a white cell SA shows a fixed threshold value and a cell SB shown by hatched lines shows a variation threshold value. In the example of FIG. 13A, a matrix of 8 lateral pixels and 4 longitudinal pixels is assembled and an extremely-protruded value is set as the variation threshold value of the cell SB shown by hatched lines. In the quantization condition A, the quantization threshold value for each pixel in one block ((N×M) pixels) cyclically changes based on the matrix ((8×4) pixels) as described above. FIG. 13B shows the cycle of the change of the quantization threshold value in the quantization condition B. In the example of FIG. 13B, a matrix of 4 lateral pixels and 8 longitudinal pixels different from those of FIG. 13A is assembled and an extremely-protruded value is set as the variation threshold value of the cell SB shown by hatched lines. In the quantization condition B, the quantization threshold value for each pixel within one block ((N×M) pixels) cyclically changes based on such a matrix ((4×8) pixels).

As described above, when one pixel is expressed by a gradation value of 8 bits, the fixed threshold value is set as “128” as an example and the protruded variation threshold value is set to “10”. When a low quantization value is used, the quantization value of the target pixel tends to be “1” (typical quantization value of “255”). Thus, in any of FIG. 13A and FIG. 13B, the quantization values “1” are easily arranged so as to correspond to the array of the cells SB shown by the hatched lines. In other words, for the respective block of (N×M) pixels, a block in which dots are formed in the array of the cells SB shown by the hatched lines in FIG. 13A and a block in which dots are formed in the array of the cells SB shown by the hatched lines in FIG. 13B coexist.

A slight change in the quantization threshold value in the error diffusion does not have an influence on the quality of the printed image. In the organized dithering, the quality of an image expressed by gradation is significantly different depending on a used dithering pattern. However, in the error diffusion method to cyclically change the quantization threshold value as described above, a slight change in the arrangement of dots or a texture for example may occur but such a change has very little influence on the quality of an image expressed by gradation. The reason is that, even when a quantization threshold value changes, an error representing a difference between the signal value and the quantization value is always diffused to peripheral pixels and thus an inputted signal value is stored in a macroscopic manner. Specifically, very-high redundancy is obtained in the dot arrangement in the error diffusion and texture generation.

### (Conveying Amount Guessing Unit)

Based on the quantization conditions A and B set in the manner as described above, the yellow ink image information is subjected to a quantization processing. Based on the quantization information, the printing unit 504 of FIG. 9 including the printing head ejects yellow ink on the sheet 8 to print an image. The printed image is optically read by the reading unit 505 of FIG. 9 including the sensor unit 21. The conveying amount guessing unit 506 of FIG. 9 decodes, based on the read information, the superimposed electronic watermark information to thereby guess the conveying amount of the sheet 8.

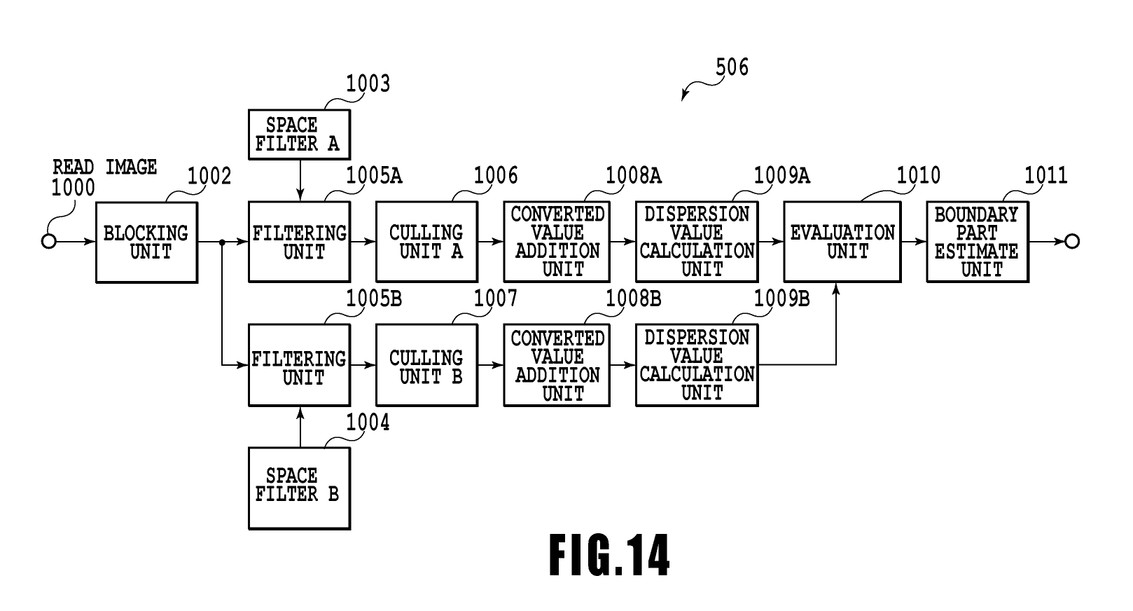

FIG. 14 is a block diagram illustrating a main part of the conveying amount guessing unit 506. The image information read by the reading unit 505 is inputted to an input terminal 1000. The image sensor 305 of the sensor unit 21 in the reading unit 505 (see FIG. 3A) preferably has a resolution that is equal to or higher than the image printing resolution. In order to accurately read the information regarding dots dispersed over the sheet 8, a sampling theory requires that the reading resolution of the reading unit 505 is two times or more higher than the printing resolution of the printing unit 504. However, if the resolution of the former is equal to or higher than the resolution of the latter, the dispersion of the dots can be determined at a certain accuracy. In this example, for the purpose of simple explanation, it is assumed that the image sensor 305 has a resolution equal to the printing resolution.

In FIG. 14, a blocking unit 1002 converts the read image to a block based on the lateral P pixels and longitudinal Q pixels. This block is used as a unit to compound the read image to obtain electronic watermark information. This block has a size equal to or smaller than (N×M) pixels converted to a block during the superimposition of the electronic watermark information. Specifically, P≦N and Q≦M are established.

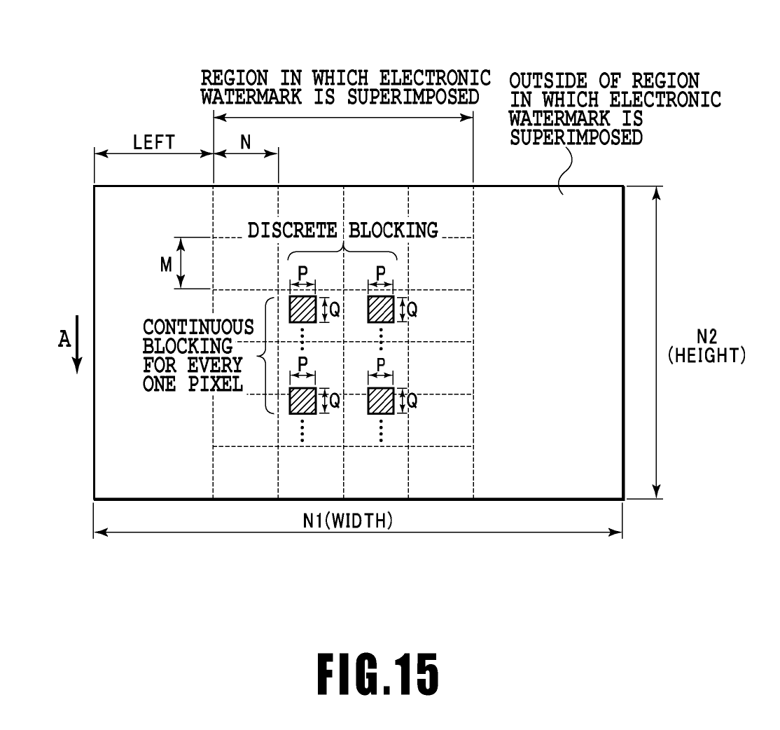

FIG. 15 illustrates the read image converted to a block of (P×Q) pixels. The conversion to a block of (P×Q) pixels (shown by the hatched lines) is carried out discretely with an interval in the sheet width direction (horizontal direction) and is carried out continuously in the sheet conveying direction (vertical direction).

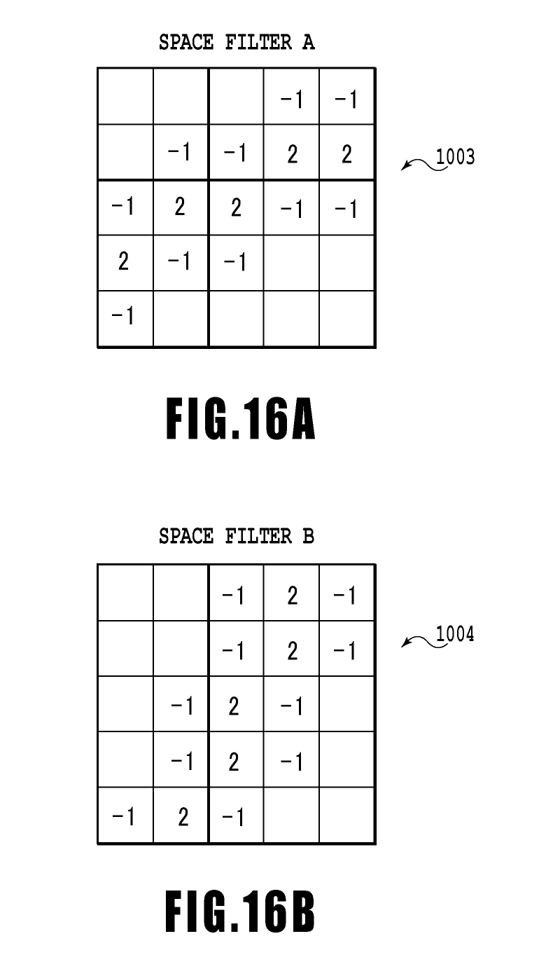

In FIG. 14, the reference numerals 1003 and 1004 represent space filters A and B having different characteristics. The reference numerals 1005A and 1005B represent a digital filtering unit to calculate the product sum with peripheral pixels. The respective coefficients of the space filters A and B are prepared so as to correspond to the cycle of the variation threshold values of the quantization conditions during the superimposition of electronic watermark information. It is assumed that the electronic watermark information is superimposed by changing the quantization condition as shown in FIG. 13A and FIG. 13B. In this case, the space filter A 1003 of FIG. 16A and the space filter B 1004 of FIG. 16B are used to decode the electronic watermark information. In FIGS. 16A and 16B, the center part of (5×5) pixels is a target pixel and 24 pixels other than the above pixels are peripheral pixels. In these drawings, the pixels in a blank part represent that the filter coefficient is “0”. As can be seen from these drawings, the space filters A and B of this example function as an edge highlight filter. The direction of the highlighted edge is the same as the direction of the variation threshold value during the superimposition of the electronic watermark information. Specifically, the space filter A 1003 of FIG. 16A is prepared so as to correspond to the quantization condition A of FIG. 13A and the space filter B 1004 pf FIG. 16B is prepared so as to correspond to the quantization condition B of FIG. 13B.

In FIG. 14, a culling unit A 1006 and a culling unit B 1007 subject a filtered signal within a block consisting of (P×Q) pixels (hereinafter referred to as “converted value”) to a culling processing based on a certain regularity, respectively. In this example, the regularity of the culling is divided to cyclicity and a phase. Specifically, the culling operations in the culling unit A 1006 and the culling unit B 1007 have different cyclicities and execute a plurality of culling processings using different phases, respectively. These culling processings will be described later.

Converted value addition units 1008A and 1008B add the converted values subjected to the culling processing by the culling unit A 1006 and the culling unit B 1007 for the respective phases, respectively. The culling processing and the addition processing of the converted value correspond to the extraction of the power of the predetermined frequency vector highlighted by the space filter. Dispersion value calculation units 1009A and 1009B calculate the dispersion of a plurality of addition values added for the respective phases in the respective cyclicities. An evaluation unit 1010 evaluates the accuracy of the sign (0, 1) of the superimposed electronic watermark information by a numerical conversion based on the dispersion values at the respective cyclicities. A boundary part estimate unit 1011 estimates, based on a plurality of evaluation results by the evaluation unit 1010, the position at which the superimposed sign (0, 1) is switched to thereby estimate the boundary between blocks.

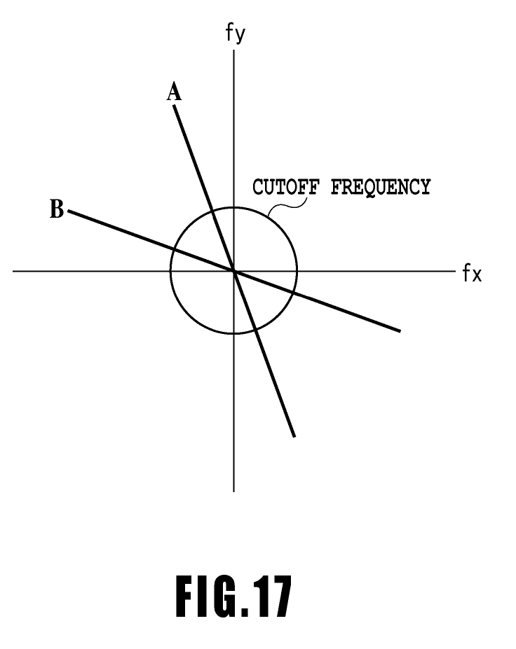

FIG. 17 is a schematic view illustrating the present invention in a two-dimensional frequency region. In FIG. 17, the horizontal axis shows the frequency in the horizontal direction while the vertical axis shows the frequency in the vertical direction. The origin at the center shows a DC component for which the high frequency region increases with an increase of the distance from the origin. The circle in the drawing represents the cutoff frequency by the error diffusion. The filter characteristic in the error diffusion shows the characteristic of an HPF (high-pass filter) for which a low-frequency area is cut off. The cut off frequency changes depending on the density of a target image. In this example, a change of the quantization threshold value causes a change of the frequency characteristic occurring after the quantization. The change of the quantization threshold value by the quantization condition A of FIG. 13A causes a high power spectrum on the frequency vector of the straight line A in FIG. 17. On the other hand, the change of the quantization threshold value by the quantization condition B of FIG. 13B causes a high power spectrum on the frequency vector of the straight line B in FIG. 17.

By detecting the frequency vector causing a high power spectrum as described above, the superimposed electronic watermark information is determined. To realize this, the respective frequency vectors are individually extracted in a highlighted manner. Each of the space filters A and B of FIG. 16A and FIG. 16B corresponds to the HPF having a direction of a specific frequency vector. Specifically, the space filter A 1003 of FIG. 16A can be used to highlight the frequency vector on the straight line A. The space filter B 1004 of FIG. 16B can be used to highlight the frequency vector on the straight line B. For example, it is assumed that the quantization condition A of FIG. 13A causes a high power spectrum on the frequency vector of the straight line A in FIG. 17. In this case, the space filter A of FIG. 16A amplifies the change amount of the power spectrum. The space filter of FIG. 16B amplifies a very little amount of the change of the power spectrum. Specifically, a plurality of space filters are used in a parallel manner for filtering, only one space filter having the same frequency vector amplifies the change amount of the power spectrum and amplify a very little amount of the change of the other filters. This can consequently easily find which frequency vector has thereon a high power spectrum.

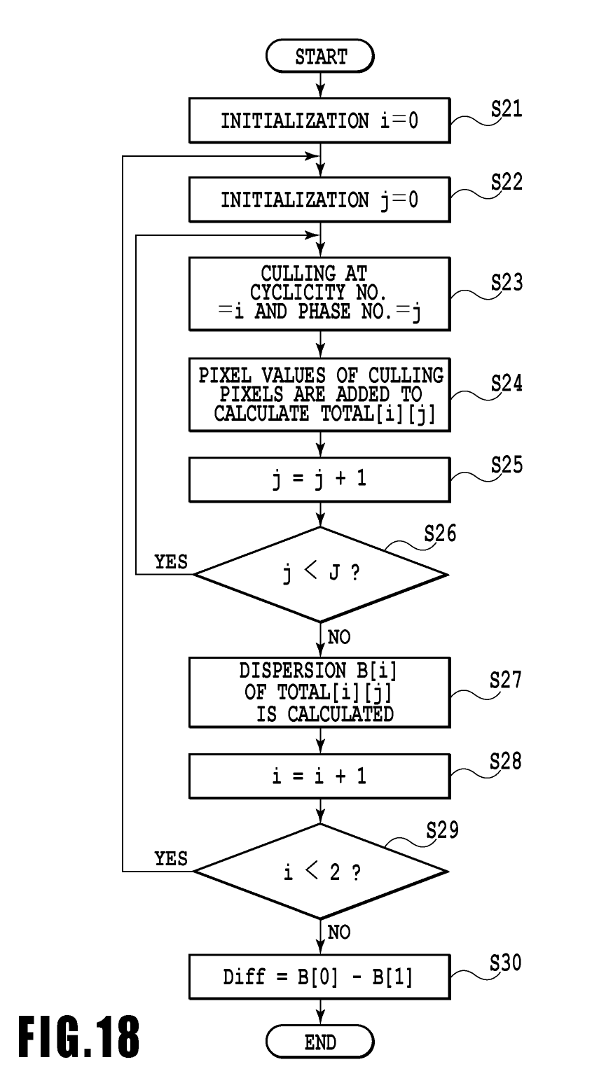

FIG. 18 is a flowchart illustrating the operation procedure of the culling units 1006 and 1007, the converted value addition units 1008A and 1008B, the dispersion value calculation units 1009A and 1009B, and the evaluation unit 1010 in FIG. 14.

First, in steps S21 and S22 in FIG. 14, the values of the variables i and j are initialized to “0”. Next, step S23 determines the rule factors regarding the culling by the culling units 1006 and 1007 (i.e., two factors of “cyclicity” and “phase”). In this example, the variable regarding the cyclicity is represented as i while the variable regarding the phase is represented as j. The cyclicity and phase conditions are controlled based on the numbers. The culling rule factors are set for which the cyclicity number (hereinafter simply referred to as “cyclicity NO.”) is i while the phase number (hereinafter simply referred to as “phase NO.”) is j.

Next, step S24 adds the converted value subjected to the culling in a block consisting of (P×Q) pixels. The added value is stored as a variable array TOTAL[i][j]. Step S25 increments the variable j. Step S26 compares the counted variable j with a fixed value J. As the fixed value J, the number at which a phase is changed and the culling processing is performed is stored. If the variable j is smaller than J, the processing returns to step S23. Then, the condition of the new phase NO. using the counted variable j is used to repeat the culling processing (step S23) and the processing to add the culling pixel (step S24).

When the culling processing and addition processing using a shifted phase as described above is repeated for the number corresponding to the fixed value J, step S27 calculates the dispersion value of the addition result TOTAL[i][j]. Specifically, with regard to the addition result TOTAL[i][j], the average value of the respective addition results is calculated, a difference between the average value and each sample is calculated, and the square sum of the difference is calculated to thereby calculate the dispersion value. Specifically, how the respective addition results are dispersed depending on the phase difference is evaluated. Here, the variable i is fixed and the dispersion value B[i] of J TOTALs[i][j] is calculated. Next, step S28 increments the variable i. Step S2 determines whether the variable i is smaller than 2 or not. If the variable i is smaller than 2, the processing returns to step S22 to use the condition of the new cyclicity NO. using the counted variable i. Then, the culling processing (step S23) and the culling pixel addition processing (step S24) are repeated again.

When step S29 determines that the culling processing and addition processing using a shifted cyclicity as described above is repeated two times, it means that two values of B[0] and B[1] can be calculated as the dispersion value B[i]. Next, step S30 calculates a difference between B[0] and B[1] as the variable Diff.

The processing as described above calculates Diff with regard to one block obtained by the blocking conversion. Thereafter, the read image is block-converted while being shifted in the sheet conveying direction by one pixel to repeat again the operation procedure of FIG. 18.

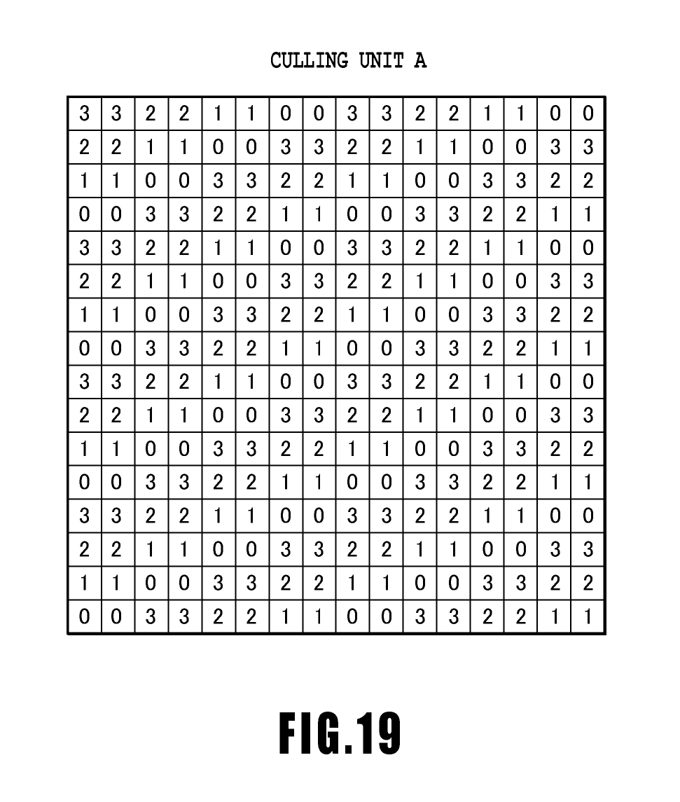

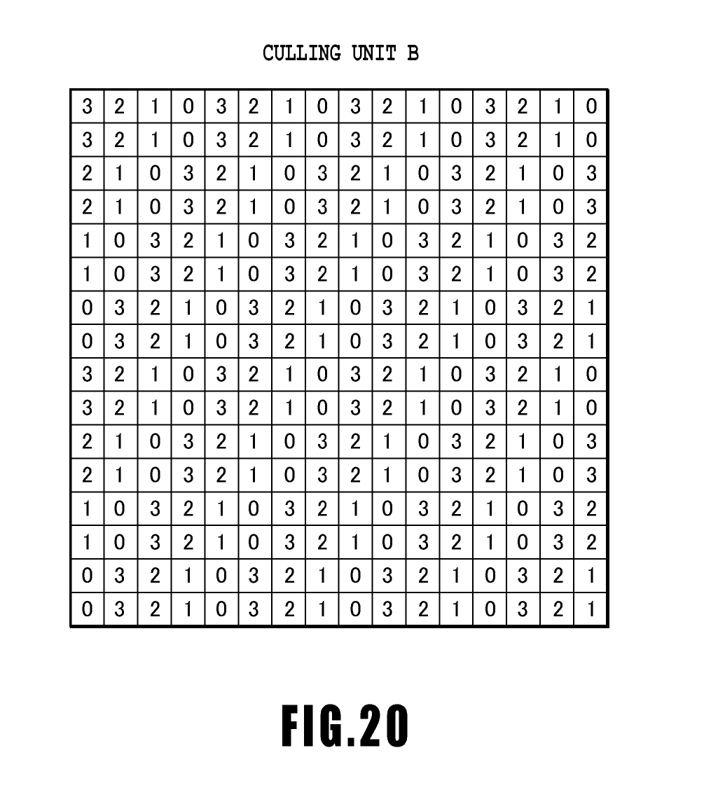

As a specific example, the operation when J=4 is established will be described. FIG. 19 and FIG. 20 illustrate the culling method when the block size is P=Q=16 based on a table. In the drawings, one cell in one block (16×16) shows a pixel. In the drawings, the block has a square shape of P=Q. However, the invention is not limited to a square shape and also may use shapes other than a rectangle shape. FIG. 19 illustrates the culling method when the cyclicity NO.=0 (which corresponds to the culling unit A 1006 in FIG. 14). FIG. 20 illustrates the culling method when the cyclicity NO.=1 (which corresponds to the culling unit B 1007 in FIG. 14). In these drawings, the values shown on the respective pixels within the block show the value of i representing the phase NO. For example, the pixel shown as “0” corresponds to the culling pixel when j=0. Specifically, the culling method of FIG. 19 and FIG. 20 is a culling method when four types of phases are used and the phase NO.j is 0 to 3.

The culling cyclicity in FIG. 19 is the same as the quantization cyclicity in FIG. 13A. The culling cyclicity in FIG. 20 is the same as the quantization cyclicity in FIG. 13B. As described above, in FIG. 13A and FIG. 13B, the quantization values “1” (when binary values of “0” and “1” are used) are easily arranged so as to correspond to the arrangement of cells shown by the hatched lines. Thus, with regard to the block having the quantization condition A during the superimposition of the electronic watermark information for example, the quantization values “1” are easily arranged at the cyclicity in FIG. 13A. Thus, the filtering using a space filter adapted to this is used to further amplify the frequency components thereof. Furthermore, when the converted values are culled and added at the cyclicity in FIG. 19, the addition result has increased dispersion. On the other hand, when the block having the quantization condition A during the superimposition of the electronic watermark information is filtered using a space filter not adapted to this and the converted value is culled and added at the cyclicity of FIG. 20, the resultant addition result has reduced dispersion value. The reason is that the quantization value has cyclicity different from that of the culling and thus the addition values of the converted value due to the difference in the culling phase are averaged and thus the dispersion is reduced.

When the block having the quantization condition B during the superimposition of the electronic watermark information is subjected to the culling of FIG. 19, the dispersion value is reduced. When the block having the quantization condition B during the superimposition of the electronic watermark information is subjected to the culling of FIG. 20, the dispersion value is increased.

In the example of the flowchart of FIG. 11, bit=0 is set as the quantization condition A and bit=1 is set as the quantization condition B. Thus, bit=0 can be determined when the dispersion value when cyclicity NO.=0 is established is high, while BIT=1 can be determined when the dispersion value when cyclicity NO.=1 is established is high. Specifically, by associating the quantization condition, the space filter characteristic, and the cyclicity of the culling condition, the superimposition and separation of the electronic watermark information can be easily realized. Thus, without requiring compare the frequency power values corresponding to the quantization condition rules by the orthogonal transformation, signs can be easily separated. Furthermore, the processing of the actual space region can realize the separation processing at a very high speed.

### (Method of Estimating a Boundary Part)

Next, the following section will describe a method of estimating a boundary part of a block.

FIG. 21 illustrates the transition of the variable Diff in which the horizontal axis shows the number of blocks (block number) in the sheet conveying direction while the vertical axis shows the Diff value. The black circle points show the Diff values corresponding to the respective block numbers.

As described above, the Diff value shows the accuracy of the sign obtained by decoding each block (0 or 1). As can be seen from FIG. 15, when a block consisting of (P×Q) pixels used for decoding is included in a block consisting of (M×N) pixels during printing, the accuracy of the decoded sign “0” or the accuracy of the decoded sign “1” is increased. On the other hand, when a block consisting of (P×Q) pixels is not included in a block consisting of (M×N) pixels and thus the pixels of a plurality of blocks are referred to bridge the block boundary during printing, the above-described values of B[0] and B[1] are closer to each other and the Diff value is close to zero. When the block consisting of (P×Q) pixels exceeds the block boundary during printing, the Diff value exceeds zero and is switched to an opposite sign. A position at which the Diff value is zero is estimated as the block boundary position during printing.

The method of estimating the position at which the Diff value may take a value of zero includes various methods including, for example, a method of estimating such a position by linear interpolation based on two points at which the Diff value is switched from positive to negative or negative to positive, a method of estimating such a position using a high order interpolation based on a plurality of Diff values of two or more points, and a method of estimating such a position using a known interpolation method (e.g., a Bezier curve or a spline curve).

By estimating the block boundary, the gap between the distance between block boundaries and the distance on the logical coordinate can be evaluated. When the estimated distance between the block boundaries (block boundary travel amount) is longer than a distance used as a predetermined reference (travel amount), then it can be determined that the sheet conveying speed is increased. When the estimated distance between the block boundaries is shorter than the distance used as the predetermined reference on the other hand, it can be determined that the sheet conveying speed is reduced.

### (Printing Control Unit)

The printing control unit 507 in FIG. 9 subjects, based on the determination result of the sheet conveying speed as described above, the printing unit 504 to a feedback control. When the conveying speed is reduced, the ink ejection timing at the printing unit 504 is controlled to be delayed. When the conveying speed is increased on the other hand, the ink ejection timing at the printing unit 504 is controlled to be brought forward. This control can realize the printing operation depending on the actual conveying speed.

Another feedback control method includes a method of controlling the conveying speed. When the conveying speed is slow, the rotation speed of the convey roller 11 is controlled to be increased. When the conveying speed is high on the other hand, the rotation speed of the convey roller 11 is controlled to be reduced. These feedback controls allow, even when the conveying speed varies, the sheet 8 to have thereon a printing result for which a printing defect due to the variation is reduced.

The method of controlling the ejection timing to correct the printing result on the sheet 8 can accurately control the ejection and thus can correct the result accurately. However, this method is limited by the capacity of buffering the printing data in the printing unit 504 and the convenience of the data processing in the entire system. If the ejection timing is brought forward, printing data is insufficient. If the ejection timing is delayed on the other hand, the printing data cannot be buffered and may overflow.

When the conveying speed is controlled on the other hand, it is difficult to increase the accuracy higher than that at which the ejection timing is controlled but the allowable correction range is wide. In an actual case, it is effective to combine these control methods depending on the shift of the conveyed distance of the sheet. As an example, when the shift amount is large, the control of the conveying speed is actively used to perform correction. When the shift amount is small, the ejection timing is controlled to perform correction. However, when the correction based on the control of the ejection timing is carried out for a long time, excessive or insufficient data processing is caused. Thus, in such a case, the conveying speed may be controlled so as to reduce the excessive or insufficient data processing.

In this embodiment, by changing the threshold value of the pseudo gradation processing to increase the power of the predetermined frequency, electronic watermark information is superimposed on a low-frequency component lower than the quantization frequency in a less visually-recognized manner. By superimposing the electronic watermark information on the low-frequency component as described above, higher robustness is obtained, which is particularly preferred in a printing apparatus such as an inkjet printing apparatus in which dots are landed unstably. In this embodiment, the culling cyclicity of FIG. 13A and FIG. 13B has been exemplarily described. However, on which frequency the electronic watermark is superimposed is preferably determined by an experiment based on the stability of the apparatus. Furthermore, in this embodiment, an example was described in which the electronic watermark is superimposed for only an image of yellow ink. However, ink for which the electronic watermark information is superimposed is not limited to yellow ink but also may be inks of other colors.

### Second Embodiment

In the first embodiment, the electronic watermark information is superimposed only on an image of ink of yellow ink (i.e., an image of a single color). In the inkjet printing apparatus, a position on a sheet at which ink ejected from a printing head is landed (i.e., an ink dot formation position) may have an error. Thus, in order to more appropriately know the sheet conveying amount, the electronic watermark information is preferably printed by superposing ink dots of a plurality of colors than a case where the electronic watermark information is printed by ink dots of a single color. Inks of a plurality of colors also may be selectively used to print the electronic watermark information. For example, in a light yellow region on the sheet on which only yellow ink dots are formed, the electronic watermark information can be printed by yellow dots. In a light cyan region on the sheet on which only cyan ink dots are formed, the electronic watermark information can be printed by cyan dots.

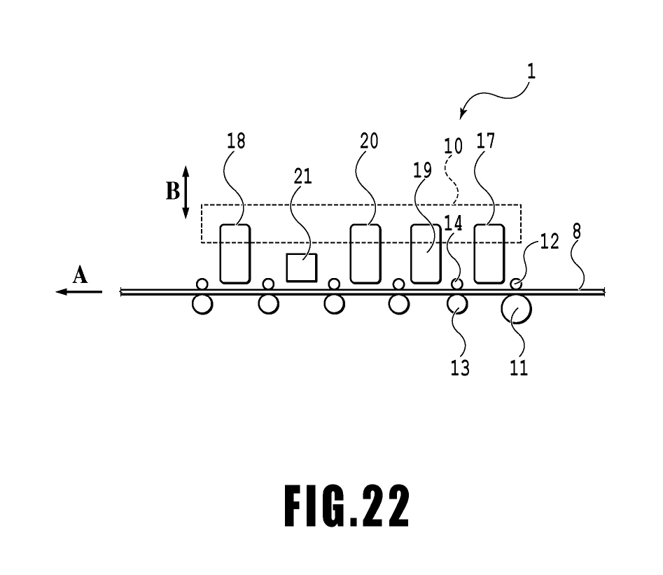

In the second embodiment, a plurality of chromatic ink dots are superposed to print the electronic watermark information. FIG. 22 is a side view illustrating the configuration of the printing unit 1 in this embodiment. The printing unit 1 in this embodiment is different from the above-described printing unit 1 in the embodiment of FIG. 2A in the layout of the printing heads 17 to 20 and the sensor unit 21. In this embodiment, an image on which the electronic watermark information is superimposed is printed using the printing head 17 to eject yellow ink, the printing head 19 to eject cyan ink, and the printing head 20 to eject magenta ink. Then, the image is read by the sensor unit 21. In this manner, inks of the three chromatic colors of yellow, cyan, and magenta are used to superimpose the electronic watermark information used as space information that can be sensed. The method of superimposing and reading the electronic watermark information using the respective inks may be similar to that of the first embodiment. Alternatively, a pattern to change the quantization threshold values of FIG. 13A and FIG. 13B also may be changed for each ink color (or each color material) and the space filters of FIG. 16A and FIG. 16B are changed depending on the change pattern so that a different electronic watermark characteristic can be used for each ink color. In this case, robustness can be further increased.

### Third Embodiment

In the second embodiment, all of the chromatic color inks are used to print electronic watermark information. An increase of used ink colors causes the electronic watermark information to be more visually recognized, thus easily causing a printed matter having a deteriorated quality.

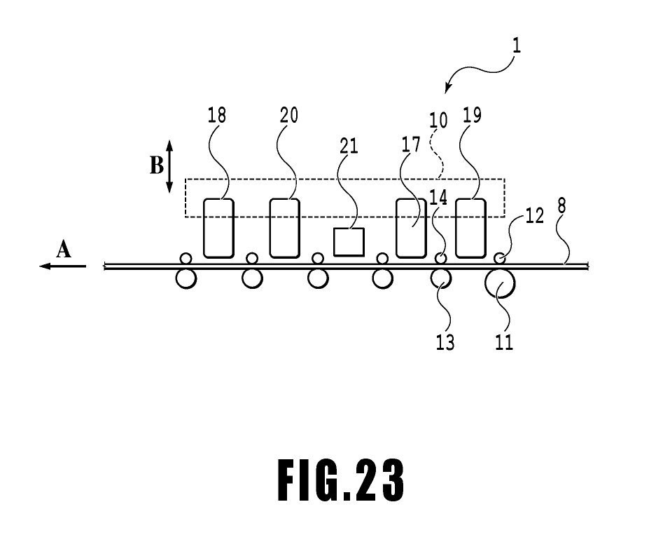

The printing unit 1 in the third embodiment is configured as shown in FIG. 23 in which the printing head 19 to eject cyan ink and the printing head 17 to eject yellow ink are used to print an image on which electronic watermark information is superimposed. The printed image is read by the sensor unit 21. According to the optical characteristic of the sensor unit 21 of FIG. 4, the characteristic of B(blue) is separated from the characteristic of R(red). Thus, the electronic watermark information is superimposed using yellow ink and cyan ink that are complementary colors of these filters to thereby more easily separate the signals of these ink colors in accordance with the optical characteristic of the sensor unit 21. As a result, only the use of the two colors of yellow and cyan inks can increase the detection at which the electronic watermark information can be detected.

### Fourth Embodiment

In the above-described first to third embodiments, the sensor unit 21 includes the respective color filters of R (red), G(green), and B(blue). The configuration including a plurality of filters as described above tends to cause the sensor unit 21 to have complexity and a high cost.

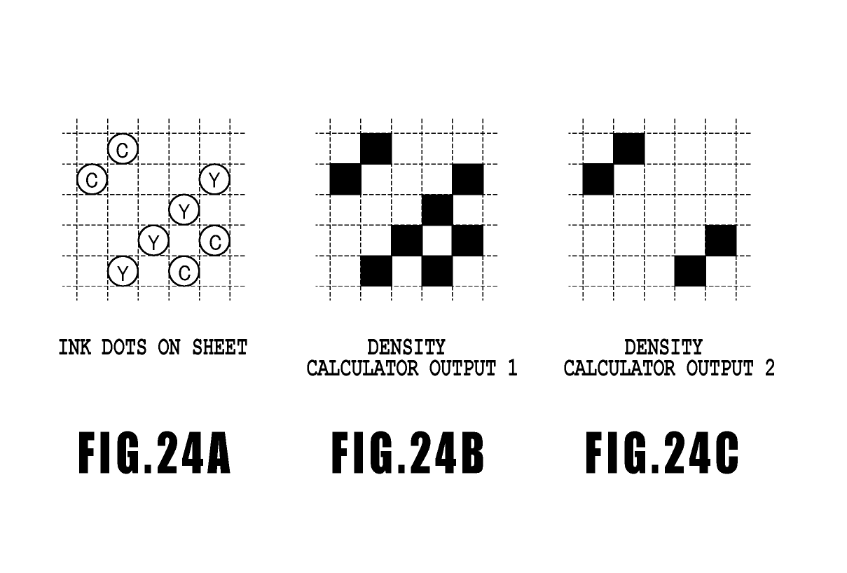

In the fourth embodiment, the sensor unit 21 does not include the respective color filters and uses a density calculator that acquires the density of a printed image (i.e., light-dark information) only. This density calculator can binarize the sheet density and the dot density in a separated manner to thereby output a binary image for which the existence or nonexistence of dots on the sheet can be determined. For example, when the sheet has thereon cyan ink dots (cyan dots) C and yellow ink dots (yellow dots) Y as shown in FIG. 24A, the density calculator senses these dots and outputs the binary image (output 1) as shown in FIG. 24B.

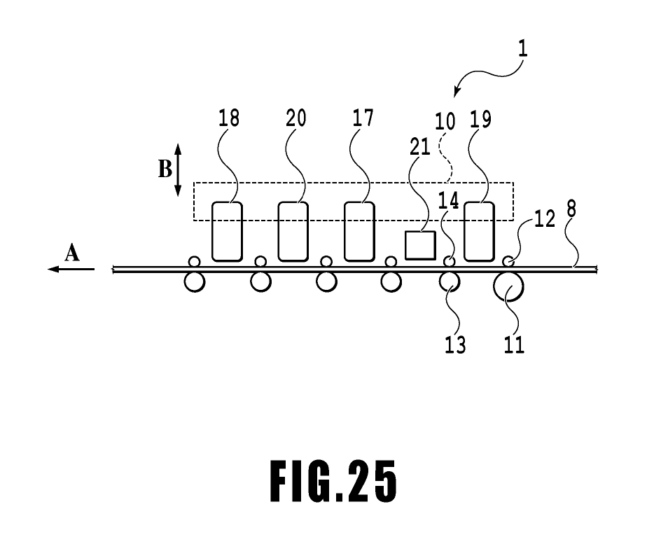

When the electronic watermark information is superimposed on a cyan ink image, a configuration as shown in FIG. 25 is used in which only the printing head 19 to eject cyan ink is provided at upstream side in the sheet conveying direction than the density calculator functioning as the sensor unit 21. This configuration allows the density calculator to output, as shown in FIG. 24C, the binary image (output 2) for which only cyan dots superimposed with the electronic watermark information are sensed.

### Fifth Embodiment

If the number of dots formed by ink to print an image superimposed with the electronic watermark information (e.g., low density ink) is too small, the electronic watermark information may be prevented from being superimposed. In this embodiment, ink having a density equal to or lower than a predetermined density is used to print a visible marker consisting of a chunk of a predetermined number of dots. This marker is used to sense the space information.

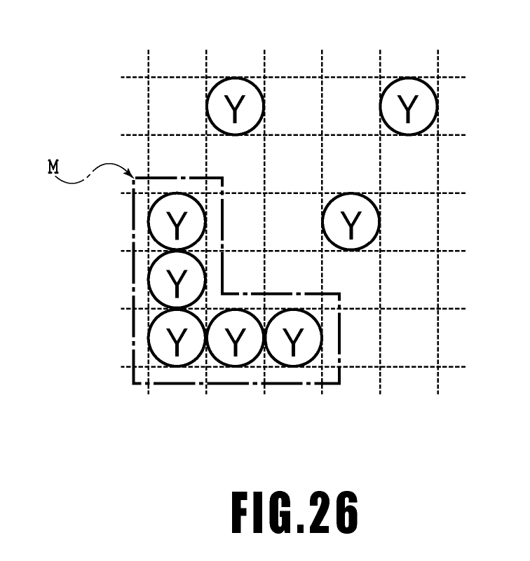

For example, as shown in FIG. 26, yellow ink is used as ink having a density equal to or lower than a predetermined density. The yellow ink is used to print a visible marker on a sheet. An L-shaped pattern composed of six yellow dots shown at the lower-left side of FIG. 26 is a marker M and yellow dots other than this are dots to print an image. In the L-shaped pattern used as the marker M, the coordinate of the intersection of the vertical line and the horizontal line can be used as the space information to thereby sense the marker M even with low-density ink. Furthermore, in order to allow the marker M to be less visually recognized, yellow ink is preferably used because yellow ink has a small difference in density from the density of the white sheet for example.

### Other Configuration Examples

In the case of a printing apparatus using light color ink such as light cyan or light magenta, these inks may be used to print an image on which electronic watermark information is superimposed. For example, the combination of yellow ink and cyan ink used in the third embodiment may be substituted with the combination of yellow ink and light cyan ink. The substitution of cyan ink with light cyan ink allows, while easily separating the signals of the two ink colors used to print an image on which electronic watermark information is superimposed, the electronic watermark pattern to have a low density so that the pattern can be less visually recognized.

In the case of a printing apparatus using particular colors such as red, green, orange, or violet, these inks may be used to print an image on which electronic watermark information is superimposed. For example, the combination of yellow ink and cyan ink used in the third embodiment may be substituted with the combination of yellow ink and violet ink. The violet ink consists of a cyan component and a magenta component. Thus, signal components transmitted through R (red) and G(green) filters can be analyzed to thereby sense the electronic watermark information.

When such light color ink or particular color ink is used to print an image on which electronic watermark information is superimposed, the upstream side in the conveying direction of the sensor unit 21 does not have a printing head to eject ink of a color similar to that of the ink to print such an image. For example, cyan ink and light cyan ink as well as cyan ink and violet ink are all ink colors that influences on the signal components transmitted through the R (red) filter and thus undesirably interfere each other.

In the above description, a configuration was described in which an image on which electronic watermark information is superimposed is printed and the electronic watermark information is recovered to identify the space coordinate to thereby detect the sheet conveying amount. Based on the detection result, the ink ejection timing is subjected to a feedback control. A method of superimposing the electronic watermark information includes various methods, including, for example, a method of partially changing image printing conditions to use the changed part as watermark, a method of using a frequency or color material (e.g., ink or toner) that is less visually recognized to superimpose the electronic watermark information. The feedback control also can be performed not only on the ink ejection timing but also on the sheet conveying amount (including a conveying speed (the conveying amount per a unit time)).

According to the present invention, as a printing head to print information for sensing a sheet conveying amount, a special printing head is not required. Chromatic ink is used to print an image including information for sensing the sheet conveying amount. When the information for sensing the sheet conveying amount is printed by electronic watermark information superimposed on printing data, a slight difference in the image quality when the quantization condition of the printing data is cyclically changed can be used to sense the sheet conveying amount. Based on the sensed conveying amount, information to correct the image print timing or the sheet conveying amount for example can be acquired. In the double-side printing in which images are printed both of the top face and the back face of a sheet, based on the acquired information, the image printing timing or the sheet conveying amount for example can be subjected to a feedback control so as to suppress the deviation of the printed images on the top face and the back face of the sheet.

According to the present invention, at a timing after an image including information used to control the printing is printed on a printing medium by chromatic material and before the image is printed by achromatic material, the information printed by chromatic material is read. As a result, the information printed by chromatic material can be read without being influenced by the achromatic material. The method of printing the information printed by chromatic material is not limited to an embedding method using an electronic watermark and may include, for example, a method of printing a mark at a predetermined position in an actual image. What is important is that the information is read without being influenced by achromatic material. Furthermore, the information printed by chromatic material is not limited to information regarding the conveying amount of the printing medium and can include, for example, information that can be used to control the image printing such as the meandering amount during the conveyance of a printing medium.

The present invention can be widely applied not only to an inkjet printing apparatus using a printing head through which ink can be ejected but also to various types of printing apparatuses in which various color materials such as ink or toner are used to print an image. In such a case, information to sense the sheet conveying amount for example can be acquired to carry out a feedback control on the position at which the printing of the image is started or the sheet conveying speed to thereby print a high-quality image in various types of printing apparatuses.

The present invention is also realized by carrying out the following processing. Specifically, software (program) to realize the function of the above-described embodiment is supplied via a network or various storage media to the system or apparatus so that the computer of the system or apparatus (or CPU or MPU for example) can read and execute the program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-154830, filed Jul. 30, 2014, which is hereby incorporated by reference wherein in its entirety.

What is claimed is:

1. A printing apparatus for printing an image on a printing medium conveyed in a conveying direction using a plurality of color materials including chromatic material and achromatic material, comprising:
a first printing unit configured to use at least one of the chromatic materials to print, on the printing medium, an image including information used to control the printing,
a second printing unit configured to use the achromatic material to print an image on the printing medium,
a reading unit configured to read the information, and
a printing control unit configured to calculate, based on the information read by the reading unit, a conveying amount of the printing medium to perform a printing control,
wherein:
the reading unit is positioned at a downstream side of the conveying direction than the first printing unit and at a upstream side in the conveying direction than the second printing unit.

2. The printing apparatus according to claim 1, wherein the first printing unit prints the information so that the image to be printed by the first printing unit is associated with a plurality of divided blocks.

3. The printing apparatus according to claim 1, wherein the information includes information to sense the conveying amount of the printing medium.

4. The printing apparatus according to claim 1, wherein the first printing unit prints the image including the information based on printing data for which the information is superimposed by an electronic watermark.

5. The printing apparatus according to claim 4, comprising:
a quantization unit configured to quantize image data in order to generate printing data, and
an electronic watermark superimposition unit configured to change a quantization condition of the quantization unit so as to superimpose the information on the printing data by an electronic watermark.

6. The printing apparatus according to claim 5, wherein
the first printing unit prints the image including the information using two or more different chromatic materials, and
the electronic watermark superimposition unit causes the electronic watermarks to have different characteristics depending on the two or more different chromatic materials.

7. The printing apparatus according to claim 1, wherein the first printing unit prints the image by using the chromatic material to form dots on the printing medium, and
the information is printed by a marker formed by a chunk of the dots.

8. The printing apparatus according to claim 1, comprising:
a third printing unit configured to print an image using color material similar to the chromatic material used by the first printing unit, and
the third printing unit is positioned at the downstream side in the conveying direction than the reading unit.

9. The printing apparatus according to claim 1, comprising:
a printing control unit configured to control the printing based on the information read by the reading unit.

10. The printing apparatus according to claim 9, wherein the printing control unit controls, based on the information read by the reading unit, a timing at which an image is printed by at least one of the first and second printing units.

11. The printing apparatus according to claim 9, wherein the printing control unit controls, based on the information read by the reading unit, a conveying amount of the printing medium per a unit time.

12. The printing apparatus according to claim 1, wherein
the first printing unit uses two or more different chromatic materials to print the image including the information,
the reading unit uses optical characteristics corresponding to the two or more different chromatic colors to optically read the image including the information printed by the two or more different chromatic colors.

13. The printing apparatus according to claim 1, wherein the printing control unit controls a timing at which ink is ejected.

14. The printing apparatus according to claim 1, wherein the printing control unit controls a conveying amount of the printing medium.

15. A printing method for printing an image on a printing medium conveyed in a conveying direction using a plurality of color materials including chromatic material and achromatic material, comprising:
a first printing step of using at least one of the chromatic materials to print, on the printing medium, an image including information used to control the printing,
a second printing step of using the achromatic material to print an image on the printing medium,
a reading step of reading the information after the first printing step and before the second printing step, and
a printing control step of calculating, based on the information read by the reading unit, a conveying amount of the printing medium to perform a printing control.
